(19) United States
(12) Patent Application Publication
(10) Pub. No.: US 2008/0195238 A1
(43) Pub. Date: Aug. 14, 2008

(54) Storage medium storing questionnaire answering program and questionnaire answer system

(75) Inventors: Ryutaro Takahashi, Kyoto (JP); Takafumi Masaoka, Kyoto (JP); Masanori Nakagawa, Kyoto (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 11/882,371

(22) Filed: Aug. 1, 2007

(30) Foreign Application Priority Data
Feb. 13, 2007 (JP) 2007-032758

(51) Int. Cl. G06F 19/00

(52) U.S. Cl. 700/91

(57) ABSTRACT

A game apparatus includes a CPU, and the CPU executes a questionnaire application. In the game apparatus, a player object utilized in the application is registered, and each player object makes an answer to a questionnaire. Information of the questionnaire answered by the player object is managed by corresponding player data.

### CROSS REFERENCE OF RELATED APPLICATION

The disclosure of Japanese Patent Application No. 2007-32758 is incorporated herein by reference.

### BACKGROUND OF THE INVENTION

1. Field of the Invention

The present invention relates to a storage medium storing a questionnaire answering program and a questionnaire answer system. More specifically, the present invention relates to a storage medium storing a questionnaire answer program for a questionnaire answer apparatus communicatably connected with a questionnaire delivery apparatus for delivering questionnaire data, an answer accepting apparatus for accepting answer data of a questionnaire, and a result delivery apparatus for delivering count result data of a questionnaire, and a questionnaire answer system.

2. Description of the Related Art

Conventionally, on the computer communication network, votes and questionnaires are conducted for network users. Especially, computers has become widespread in a multiplicity of ordinary households, and whereby, an environment using the Internet enables collecting answer results of votes, questionnaires, etc. at a low cost. This makes it easy to construct an automatic counting system by utilizing a computer, and collecting information of votes, questionnaire, or the like using a WWW server is heavily used.

One example of a related art of such a kind is disclosed in Japanese Patent Application Laid-Open No. 2001-229151 [G06F 17/00, G06F 13/00] (Document 1) laid-open on Aug. 24, 2001. According to the Document 1, when an address (URL) of a Web page for answer input is informed to a respondent, the respondent accesses the Web page for answer input to input attribute information of the respondent, such as sexuality, age, district, occupation, etc., and answers for a vote, a questionnaire, etc., and transmits them to a WWW server. The transmitted input data is collected by the WWW server, counted for each of the element of the above-described attribute information, and sent to the respondent as a result of the questionnaire, the vote, etc.

However, in the related art described in the Document 1, for example, on the Web page for answer input allowing an input without user authentication, a respondent cannot be specified only from the attribute information, resulting in making a plurality of answers by a single person, and intentionally operating a counting result of votes, questionnaires, etc. Furthermore, on the Web page for answer input allowing an input after performing user authentication, by erasing user information once after the answer, and newly making a registration as the same user, it is possible to make an answer again. By repeating this, similarly to a case that user authentication is not performed, it is possible to intentionally operate results of votes, questionnaires, etc. This causes a low degree of reliability in the results of the votes and the questionnaires, etc.

### SUMMARY OF THE INVENTION

Therefore, it is a primary object of the present invention to provide a novel storage medium storing a questionnaire answer program and a questionnaire answer system.

Another object of the present invention is to provide a storage medium storing a questionnaire answer program and a questionnaire answer system capable of prohibiting an unfair answer.

The present invention employs following features in order to solve the above-described problems. It should be noted that reference numerals inside the parentheses and supplement show one example of a corresponding relationship with the embodiments described later for easy understanding of the present invention, and do not limit the present invention.

A first invention is a storage medium storing a questionnaire answer program to be executed by a computer of a questionnaire answer apparatus communicably connected with a questionnaire delivery apparatus for delivering questionnaire data, an answer accepting apparatus for accepting answer data of a questionnaire, and a result delivery apparatus for delivering count result data of a questionnaire. The questionnaire answer program causes a computer of the questionnaire answer apparatus to execute a user data creating step, a questionnaire data receiving step, an answer data creating step, an answer data transmitting step, a count result data receiving step, a count result presenting step. The user data creating step creates user data and stores the user data in a storing means. The questionnaire data receiving step receives questionnaire data from the questionnaire delivery apparatus. The answer data creating step creates questionnaire answering data for each plurality of user data by presenting a questionnaire to a user by utilizing the questionnaire data received by the questionnaire data receiving step and accepting answers to the questionnaire for each plurality of user data created by the user data creating step. The answer data transmitting step transmits the questionnaire answering data created by the answer data creating step to the answer accepting apparatus. The count result data receiving step receives count result data from the result delivery apparatus. The count result presenting step presents a counting result to a user on the basis of the count result data received by the count result data receiving step.

In the first invention, a questionnaire answer apparatus (10) is communicably connected with a questionnaire delivery apparatus (104) for delivering questionnaire data (72), an answer accepting apparatus (104) for accepting answer data (74) of a questionnaire, and a result delivery apparatus (104) for delivering count result data (78) of a questionnaire. For example, the questionnaire delivery apparatus, the answer accepting apparatus and the result delivery apparatus are the same computer (server), but may be different computers. Furthermore, counting processing of the answer data accepted by the answer accepting apparatus may be executed by the answer accepting apparatus and the result delivery apparatus, and may be executed by other computers. The questionnaire answer program causes the computer of the questionnaire answer apparatus to execute a user data creating step (40, S111), a questionnaire data receiving step (42a, S23), an answer data creating step (40, S193, S197, S199, S201), an answer data transmitting step (40, S203), a count result data receiving step (42a, S23), and a count result presenting step (40, S251, S257, S263). The user data creating step creates user data (70) and stores the user data in a storing means (42e, 46). The user data is user name data and object image data corresponding to the user, for example. The questionnaire data receiving step receives questionnaire data from the questionnaire delivery apparatus. For example, the questionnaire data is transmitted from the questionnaire delivery apparatus to the questionnaire answer apparatus. Alternatively, the questionnaire answer apparatus requests the questionnaire delivery apparatus to transmit questionnaire data, and in response thereto, the questionnaire delivery apparatus may transmit questionnaire data to the questionnaire answer apparatus. In the latter, the questionnaire answer apparatus may request the questionnaire delivery apparatus to transmit questionnaire data on the basis of the preset schedule (at periodic interval, for example). The same is true for count result data described later. The answer data creating step creates questionnaire answering data for each plurality of user data by presenting a questionnaire to a user by utilizing the questionnaire data received by the questionnaire data receiving step and accepting answers to the questionnaire for each plurality of user data created by the user data creating step. For example, the answer data creating step makes it possible to accept an answer while presenting the answer about which user is accepted by utilizing the user data (user name data, object image data, for example) to the user. When accepting an answer as to certain user data, an answer result about other user data may be presented. The answer data transmitting step transmits the questionnaire answering data to the answer accepting apparatus. For example, the answer data transmitting step transmits questionnaire answering data for each user data, collectively transmits questionnaire answering data of a plurality of user data, and so forth. That is, an answer to the questionnaire for each user is transmitted to the answer accepting apparatus. The count result data receiving step receives count result data from the result delivery apparatus. The count result presenting step presents a counting result to a user on the basis of the count result data received by the count result data receiving step.

According to the first invention, an answer to the questionnaire is generated and transmitted for each user, and by managing it, it is possible to prevent fraud like answer to the same questionnaire a plurality of times by the same user. Thus, it is possible to improve reliability of the counting result of the questionnaire.

A second invention is dependent on the first invention, and the questionnaire answer program causes the computer to further execute a user data erasing step for erasing the user data from the storing means, and an erasure prohibiting step for prohibiting erasure of the user data by the user data erasing step when a user corresponding to the user data makes an answer to a questionnaire indicated by the questionnaire data.

In the second invention, the questionnaire answer program causes the computer of a questionnaire answer apparatus to further execute a user data erasing step (42, S179) and an erasure prohibiting step (42, S171, S173). The user data erasing step erases user data from the storing means. Furthermore, the erasure prohibits step prohibiting erasure of the user data when a user corresponding to the user data makes an answer to a questionnaire indicated by the questionnaire data (“NO” in S171).

According to the second invention, erasure of the user data of the user who is answering the questionnaire is prohibited, and therefore, by erasing and creating the user data of the user who has answered the questionnaire, it is possible to prevent the fraud like answer to the same questionnaire plurality of times.

A third invention is dependent on the second invention, and causes a computer to further execute a user data selecting step for selecting the user data to be erased by the user data erasing step.

In the third invention, the questionnaire answer program causes the computer of the questionnaire answer apparatus to further execute a user data selecting step (42, S47). The user data selecting step selects the user data to be erased by the user data erasing step.

According to the third invention, if even the selected user data of the user who is answering a questionnaire is present, the erasure thereof is prohibited, capable of preventing fraud similar to the second invention.

A fourth invention is dependent on the third invention, and the erasure prohibiting step excludes the user data from a candidate to be selected by the user selecting step when the user corresponding to the user data makes an answer to the questionnaire indicated by the questionnaire data.

In the fourth invention, when the user corresponding to the user data makes an answer to a questionnaire, an erasure prohibiting step excludes the user data from the candidate to be selected by the user selecting step. For example, the object image data corresponding to the user data is non-displayed or grayed out to thereby bring about an unselectable state.

According to the fourth invention, the user data corresponding to the user which is answering the questionnaire is excluded from a candidate to be selected, and even cannot be selected, capable of preventing fraud similar to the second invention.

A fifth invention is dependent on the second to the fourth invention, and the questionnaire answer program causes the computer to further execute a cancelling step for canceling the prohibition of the erasure by the erasure prohibiting step when the user data satisfies a predetermined condition.

In the fifth invention, the questionnaire answer program causes the computer of the questionnaire answer apparatus to further execute a cancelling step (42, S123, “NO” in S153). The cancelling step cancels the prohibition of the erasure by the erasure prohibiting step when the user data satisfies a predetermined condition. That is, if the predetermined condition is satisfied, the user data is erased.

According to the fifth invention, only when the predetermined condition is satisfied, the user data can be erased, capable of setting the predetermined condition being free from the fraud.

A sixth invention is dependent on the fourth invention, and the questionnaire answer program causes the computer to further execute a count result data reception determining step for determining whether or not count result data corresponding to the questionnaire answering data is received by the count result data receiving step, and the predetermined condition includes a fact that count result data corresponding to the questionnaire answering data is received by the count result data receiving step.

In the sixth invention, the count result data reception determining step (40, S129, S137) determines whether or not count result data corresponding to the questionnaire answering data is received by the count result data receiving step. That is, it is determined whether or not the counting result as to the answered questionnaire is received. The predetermined condition includes a fact that count result data corresponding to the questionnaire answering data is received. That is, when the counting result of the answered questionnaire is received, the predetermined condition is satisfied.

According to the sixth invention, after the counting result of the questionnaire is received, the user data can be erased.

A seventh invention is dependent on the fourth invention, and the questionnaire data receiving step receives a plurality of kinds of questionnaire data, and the questionnaire answer program causes the computer to further execute a count result data reception determining step for determining whether or not count result data corresponding to all the questionnaire answering data is received by the count result data receiving step, and the predetermined condition includes a fact that the count result data corresponding to all the questionnaire answering data is received by the count result data receiving step.

In the seventh invention, the questionnaire data receiving step receives a plurality of kinds of questionnaire data, and therefore, the user can make answers as to the plurality of kinds of questionnaire. Accordingly, the count result data reception determining step determines whether or not count result data corresponding to all the questionnaire answering data is received by the count result data receiving step. In a case that the count result data corresponding to all the questionnaire answering data is received by the count result data receiving step (“YES” in S171), it is determined that the predetermined condition is satisfied.

According to the seventh invention, in a case that a plurality of questionnaires are answered, a predetermined condition is satisfied when all the counting results are received, and therefore, it is possible to prevent fraud even in a case that the plurality of questionnaires are answered.

An eighth invention is dependent on the first to the seventh invention, and the user data includes history information indicating that a questionnaire indicated by the questionnaire data is answered.

In the eighth invention, the user data includes history information (70b, 70c) indicating that a questionnaire indicated by the questionnaire data is answered.

According to the eighth invention, the history of the questionnaire remains, making it difficult to select erasure of the user data. As a result, it is possible to prevent fraud.

A ninth invention is dependent on the eighth invention, and the questionnaire answer program causes the computer to further execute an answer prohibiting step for prohibiting an answer to a questionnaire corresponding to questionnaire data indicating that an answer is made in the history information.

In the ninth invention, the answer prohibiting step (40, S191, S193) prohibits an answer to a questionnaire corresponding to questionnaire data indicating that an answer is made in the history information.

According to the ninth invention, answering the answered questionnaire again is prohibited, and therefore, it is possible to prevent fraud like operating the questionnaire result by making answers to the same questionnaire a plurality of times.

A tenth invention is dependent on the first to the ninth invention, and the user data creating step creates user data in a range below a predetermined number.

In the tenth invention, the user data creating step creates user data in a range below a predetermined number (“NO” in S101). That is, the maximum number of the user data is determined in advance.

According to the tenth invention, since the user data is created by a predetermined number or below, by managing the number of answers to the same questionnaire from the questionnaire answer apparatus on the side of the answer accepting apparatus, specifically, by ignoring the number of answers exceeding the predetermined number, it is possible to prevent fraud.

An eleventh invention is questionnaire answer system including a questionnaire answer apparatus which is communicatably connected to a questionnaire delivery apparatus for delivering questionnaire data, an answer accepting apparatus for accepting answer data of a questionnaire, and a result delivery apparatus for delivering count result data of a questionnaire, and makes an answer to a questionnaire by transmitting questionnaire answering data. The questionnaire answer apparatus includes a user data creating means, a questionnaire data receiving means, an answer data creating means, an answer data transmitting means, a count result data receiving means, and a counting result presenting means. The user data creating means creates user data and storing the user data in a storing means. The questionnaire data receiving means receives questionnaire data from the questionnaire delivery apparatus. The answer data creating means creates questionnaire answering data for each plurality of user data by presenting a questionnaire to a user by utilizing the questionnaire data received by the questionnaire data receiving means and accepting answers to the questionnaire for each plurality of user data created by the user data creating means. The answer data transmitting means transmits the questionnaire answering data created by the answer data creating means to the answer accepting apparatus. The count result data receiving means receives count result data from the result delivery apparatus. The counting result presenting means presents a counting result to a user on the basis of the count result data received by the count result data receiving means.

In the eleventh invention also, similar to the first invention, it is possible to prevent fraud like answering the same questionnaire by the same user plurality of times.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing in one embodiment of a game system of this invention;

FIG. 2 is a block diagram showing an electric configuration of the game system shown in FIG. 1;

FIG. 3 is an illustrative view showing an appearance of a controller shown in FIG. 1;

FIG. 4 is a block diagram showing an electric configuration of the controller shown in FIG. 3;

FIG. 5 is an illustrative view exemplifying a state when a game is played by means of the controller shown in FIG. 1;

FIG. 6 is an illustrative view showing viewing angles of the markers and the controller shown in FIG. 1;

FIG. 7 is an illustrative view showing one example of imaged images of object images;

FIG. 8 is an illustrative view showing one example of a communication system of this invention;

FIG. 9 is an illustrative view schematically showing data stored in a flash memory integrated in the game apparatus;

FIG. 10 is an illustrative view showing one example of a task list of this embodiment;

FIG. 11 is an illustrative view exemplifying a scheduling and executing hours of tasks;

FIG. 12 is an illustrative view showing one example of an initial screen of a questionnaire application;

FIG. 13 is an illustrative view showing one example of an object selection screen;

FIG. 14 is an illustrative view showing one example of an answer screen;

FIG. 15 is an illustrative view showing one example a prediction selection screen;

FIG. 16 is an illustrative view showing one example of a prediction screen;

FIG. 17 is an illustrative view showing one example of an entire result screen;

FIG. 18 is an illustrative view showing one example of a national-results-by-region screen;

FIG. 19 is an illustrative view showing one example of an individual player screen;

FIG. 20 is an illustrative view showing one example of an erasure confirmation screen;

FIG. 21 is an illustrative view showing another example of the individual player screen;

FIG. 22 is an illustrative view showing the other example of the individual player screen;

FIG. 23 is an illustrative view showing detailed contents of player data, question data and answer data;

FIG. 24 is an illustrative view showing detailed contents of prediction data and result data;

FIG. 25 is a flowchart showing download processing of an input-output processor shown in FIG. 2;

FIG. 26 is a flowchart showing a part of the entire processing of the questionnaire application of the CPU shown in FIG. 2;

FIG. 27 is a flowchart showing another part of the entire processing of the questionnaire application of the CPU shown in FIG. 2, and continued from FIG. 26;

FIG. 28 is a flowchart showing download data acquiring processing of the CPU shown in FIG. 2;

FIG. 29 is a flowchart showing player object adding processing of the CPU shown in FIG. 2;

FIG. 30 is a flowchart showing player object erasing processing of the CPU shown in FIG. 2;

FIG. 31 is a flowchart showing question data searching processing of the CPU shown in FIG. 2;

FIG. 32 is a flowchart showing erasure executing processing of the CPU shown in FIG. 2;

FIG. 33 is a flowchart showing a part of questionnaire answering processing of the CPU shown in FIG. 2;

FIG. 34 is a flowchart showing another part of the questionnaire answering processing of the CPU shown in FIG. 2, and continued from FIG. 33;

FIG. 35 is a flowchart showing the other part of the questionnaire answering processing of the CPU shown in FIG. 2, and continued from FIG. 33 and FIG. 34;

FIG. 36 is a flowchart showing result displaying processing of the CPU shown in FIG. 2; and

FIG. 37 is a flowchart showing questionnaire updating processing of the CPU shown in FIG. 2.

### DETAILED DESCRIPTION OF THE PREFERRED EMBODIMENTS

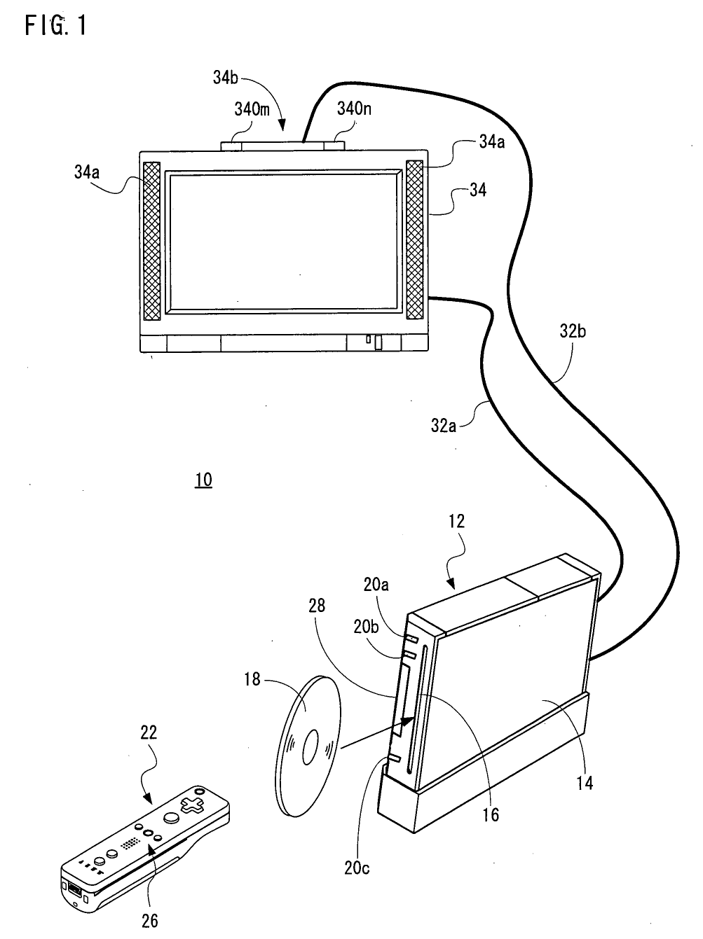

Referring to FIG. 1, a game system 10 of one embodiment of the present invention includes a video game apparatus (hereinafter referred to as “game apparatus”) 12 and a controller 22. The game apparatus 12 is incorporated with a questionnaire answer program (questionnaire application to be described below), and the game system 10 functions as a questionnaire answer apparatus.

Additionally, in this embodiment, the game apparatus 12 is designed so as to be communicably connectable with a maximum of four controllers 22. Also, the game apparatus 12 and each of the controllers 22 are connected by radio. For example, wireless communication is executed according to Bluetooth® standard, and may be executed by other standards, such as infrared rays and wireless LAN. Alternatively, they may be connected by a wire.

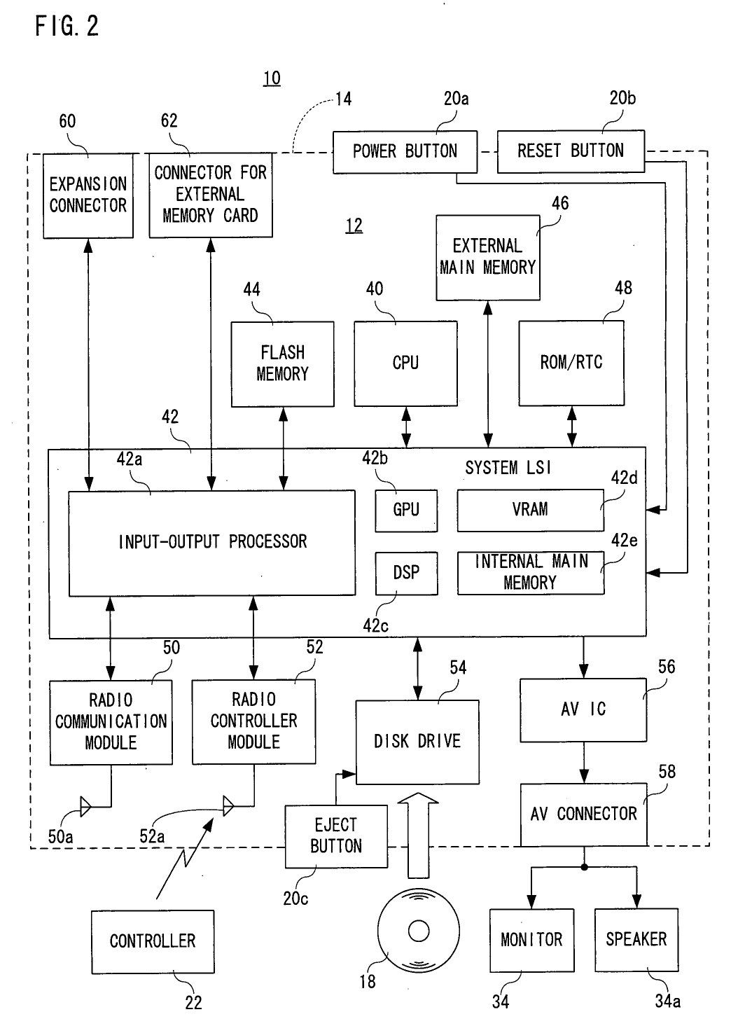

The game apparatus 12 includes a roughly rectangular parallelepiped housing 14, and the housing 14 is provided with a disk slot 16 on a front surface. An optical disk 18 as one example of an information storage medium storing game program, etc. is inserted into the disk slot 16 to be loaded in a disk drive 54 (see FIG. 2) within the housing 14. Around the disk slot 16, an LED and a light guide plate are arranged so as to be turned on in response to various processing.

Furthermore, on a front surface of the housing 14 of the game apparatus 12, a power button 20a and a reset button 20b are provided at the upper part thereof, and an eject button 20c is provided below them. In addition, a connector cover for external memory card 28 is provided between the reset button 20b and the eject button 20c, and in the vicinity of the disk slot 16. Inside the connector cover for external memory card 28, an external connector for memory card 62 (see FIG. 2) is provided, through which an external memory card (hereinafter simply referred to as a “memory card”) not shown is inserted. The memory card is employed for loading the game program, etc. read from the optical disk 18 to temporarily store it, storing (saving) game data (result data or proceeding data of the game) of the game played by means of the game system 10, and so forth. It should be noted that storing the game data described above may be performed on an internal memory, such as a flash memory 44 (see FIG. 2) inside the game apparatus 12 in place of the memory card. Also, the memory card may be utilized as a backup memory of the internal memory.

It should be noted that as a memory card, a general-purpose SD card can be employed, but other general-purpose memory cards, such as memory sticks, multimedia cards® can be employed.

The game apparatus 12 has an AV cable connector 58 (FIG. 2) on the rear surface of the housing 14, and by utilizing the AV cable connector 58, a monitor 34 and a speaker 34a are connected to the game apparatus 12 through an AV cable 32a. The monitor 34 and the speaker 34a typically are a color television receiver, and through the AV cable 32a, a video signal from the game apparatus 12 is input to a video input terminal of the color television, and a sound signal is input to a sound input terminal. Accordingly, a game image of a three-dimensional (3D) video game, for example, is displayed on the screen of the color television (monitor) 34, and stereo game sound, such as a game music, a sound effect, etc. is output from right and left speakers 34a. Around the monitor 34 (on the top side of the monitor 34, in this embodiment), a marker unit 34b including two infrared ray LEDs (markers) 34m and 34n is provided. The marker unit 34b is connected to the game apparatus 12 through a power source cable 32b. Accordingly, the marker unit 34b is supplied with power from the game apparatus 12. Thus, the markers 34m and 34n emit lights in front of the monitor 34.

Furthermore, the power of the game apparatus 12 is applied by means of a general AC adapter (not illustrated). The AC adapter is inserted into a standard wall socket for home use, and the game apparatus 12 transforms the house current (commercial power supply) to a low DC voltage signal suitable for driving. In another embodiment, a battery may be utilized as a power supply.

In the game system 10, a user or a player turns the power of the game apparatus 12 on for playing the game (or applications other than the game). Then, the user selects an appropriate optical disk 18 storing a program of a video game (or other applications the player wants to play), and loads the optical disk 18 into the disk drive 54 of the game apparatus 12. In response thereto, the game apparatus 12 starts to execute a video game or other applications on the basis of the program recorded in the optical disk 18. The user operates the controller 22 in order to apply an input to the game apparatus 12. For example, by operating any one of the input means 26, a game or other application is started. Besides the operation with respect to the input means 26, by moving the controller 22 itself, it is possible to move a moving image object (player object) in different directions or change the perspective of the user (camera position) in a 3-dimensional game world.

FIG. 2 is a block diagram of an electric configuration of the video game system 10 in FIG. 1 embodiment. Although illustration is omitted, the respective components within the housing 14 are contained on a printed board. As shown in FIG. 2, the game apparatus 12 has a CPU 40. The CPU 40 functions as a game processor. The CPU 40 is connected to a system LSI 42. The system LSI 42 is connected with an external main memory 46, a ROM/RTC 48, a disk drive 54, and an AV IC 56.

The external main memory 46 stores programs like a game program, etc., stores various data, and is utilized as a work area and a buffer area of the CPU 40. The ROM/RTC 48, the so-called boot ROM, is incorporated with a program for activating the game apparatus 12, and provided with a time circuit for counting a time. The disk drive 54 reads program data, texture data, etc. from the optical disk 18, and writes it in an internal main memory 42e described later or the external main memory 46 under the control of the CPU 40.

The system LSI 42 is provided with an input-output processor 42a, a GPU (Graphics Processor Unit) 42b, a DSP (Digital Signal Processor) 42c, a VRAM 42d and an internal main memory 42e, and these are connected with each other by internal buses although illustration is omitted.

The input-output processor (I/O processor) 42a executes transmission and reception of data, downloads of data, and so forth. A detailed description is made later as to transmission and reception and download of the data.

The GPU 42b is made up of a part of a rendering means, and receives a graphics command (construction command) from the CPU 40 to generate game image data according to the command. Additionally, the CPU 40 applies an image generating program required for generating game image data to the GPU 42b in addition to the graphics command.

Although illustration is omitted, the GPU 42b is connected with the VRAM 42d as described above. The GPU 42b accesses the VRAM 42d to acquire the data (image data: data such as polygon data, texture data, etc.) required to execute the construction command. Additionally, the CPU 40 writes the image data required for drawing to the VRAM 42d via the GPU 42b. The GPU 42b accesses the VRAM 42d to create game image data for drawing.

In this embodiment, a description is made on a case that the GPU 42b generates game image data, but in a case of executing an arbitrary application except for the game application, the GPU 42b generates image data as to the arbitrary application.

Furthermore, the DSP 42c functions as an audio processor, and generates audio data corresponding to a sound, a voice, music, or the like by means of the sound data and the sound wave (tone) data stored in the internal main memory 42e and the external main memory 46.

The game image data and audio data generated as described above are read by the AV IC 56, and output to the monitor 34 and the speaker 34a via the AV connector 58. Accordingly, a game screen is displayed on the monitor 34, and a sound (music) necessary for the game is output from the speaker 34a.

Furthermore, the input-output processor 42a is connected with an expansion connector 60 and a connector for memory card 62 as well as a flash memory 44, radio communication module 50 and a radio controller module 52. The radio communication module 50 is connected with an antenna 50a, and the radio controller module 52 is connected with an antenna 52a.

The input-output processor 42a can communicate with other game apparatuses and various servers to be connected to a network via a radio communication module 50. It should be noted that it is possible to directly communicate with other game apparatus without going through the network. The input-output processor 42a periodically accesses the flash memory 44 to detect the presence or absence of data (referred to as transmission data) being required to be transmitted to a network, and, in a case that the transmission data is present, transmits it to the network via the radio communication module 50 and the antenna 50a. Furthermore, the input-output processor 42a receives data (referred to as reception data) transmitted from other game apparatuses via the network, the antenna 50a and the radio communication module 50, and stores the reception data in the flash memory 44. If the reception data does not satisfy a predetermined condition, the reception data is abandoned as it is. In addition, the input-output processor 42a receives data (download data) downloaded from the download server via the network, the antenna 50a and the radio communication module 50, and store the download data in the flash memory 44.

Furthermore, the input-output processor 42a receives input data transmitted from the controller 22 via the antenna 52a and the radio controller module 52, and (temporarily) stores it in the buffer area of the internal main memory 42e or the external main memory 46. The input data is erased from the buffer area after being utilized in the game processing by the CPU 40.

In this embodiment, as described above, the radio controller module 52 performs communication with the controller 22 in accordance with Bluetooth standards.

In addition, the input-output processor 42a is connected with the expansion connector 60 and the connector for memory card 62. The expansion connector 60 is a connector for interfaces, such as USB, SCSI, etc., and can be connected with medium such as an external storage, and peripheral devices such as another controller. Furthermore, the expansion connector 60 is connected with a cable LAN adaptor, and can utilize the cable LAN in place of the radio communication module 50. The connector for memory card 62 can be connected with an external storage like a memory card. Thus, for example, the input-output processor 42a accesses the external storage via the expansion connector 60 and the connector for memory card 62 to store and read the data.

Although a detailed description is omitted, as shown in FIG. 1, the game apparatus 12 (housing 14) is furnished with the power button 20a, the reset button 20b, and the eject button 20c. The power button 20a is connected to the system LSI 42. When the power button 20a is turned on, the system LSI 42 set in a mode of a normal energized state in which the respective components of the game apparatus 12 are supplied with power through an AC adapter not shown (referred to as “normal mode”). On the other hand, when the power button 20a is turned off, the system LSI 42 is set to a mode in which a part of the components of the game apparatus 12 is supplied with power, and the power consumption is reduced to minimum (hereinafter referred to as “standby mode”). In this embodiment, in a case that the standby mode is set, the system LSI 42 issues an instruction to stop supplying the power to the components except for the input-output processor 42a, the flash memory 44, the external main memory 46, the ROM/RTC 48 and the radio communication module 50, and the radio controller module 52. Accordingly, the standby mode is a mode in which execution of the application is not performed by the CPU 40.

Although the system LSI 42 is supplied with power even in the standby mode, generation of clocks to the GPU 42b, the DSP 42c and the VRAM 42d are stopped so as not to be driven, realizing reduction in power consumption.

Although illustration is omitted, inside the housing 14 of the game apparatus 12, a fan is provided for excluding heat of the IC, such as the CPU 40, the system LSI 42, etc. to outside. In the standby mode, the fan is also stopped.

However, in a case that utilizing the standby mode is not desired, by making the standby mode unusable, when the power button 20a is turned off, the power supply to all the circuit components are completely stopped.

Furthermore, switching between the normal mode and the standby mode can be performed by turning on and off the power switch 26 of the controller 22 by remote control. If the remote control is not performed, setting is made such that the power supply to the radio controller module 52a is not performed in the standby mode.

The reset button 20b is also connected with the system LSI 42. When the reset button 20b is pushed, the system LSI 42 restarts the activation program of the game apparatus 12. The eject button 20c is connected to the disk drive 54. When the eject button 20c is pushed, the optical disk 18 is removed from the disk drive 54.

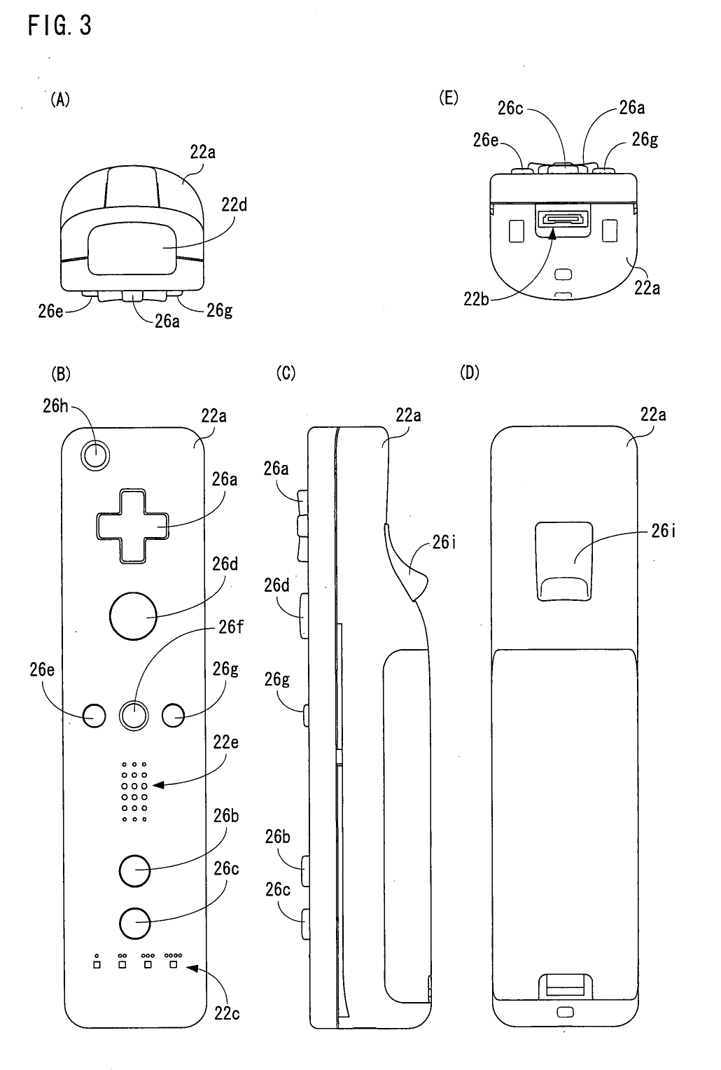

Each of FIG. 3 (A) to FIG. 3 (E) shows one example of an external appearance of the controller 22. FIG. 3 (A) shows a front end surface of the controller 22, FIG. 3 (B) shows a top surface of the controller 22, FIG. 3 (C) shows a right side surface of the controller 22, FIG. 3 (D) shows a lower surface of the controller 22, and FIG. 3 (E) shows a back end surface of the controller 22.

Referring to FIG. 3 (A) and FIG. 3 (E), the controller 22 has a housing 22a formed by plastic molding, for example. The housing 22a is formed into an approximately rectangular parallelepiped shape and has a size small enough to be held by one hand of a user. The housing 22a (controller 22) is provided with the input means (a plurality of buttons or switches) 26. Specifically, as shown in FIG. 3 (B), on an upper face of the housing 22a, there are provided a cross key 26a, a 1 button 26b, a 2 button 26c, an A button 26d, a − button 26e, a HOME button 26f, a + button 26g and a power switch 26h. Moreover, as shown in FIG. 3 (C) and FIG. 3 (D), an inclined surface is formed on a lower surface of the housing 22a, and a B-trigger switch 26i is formed on the inclined surface.

The cross key 26a is a four directional push switch, including four directions of front (or upper), back (or lower), right and left operation parts. By operating any one of the operation parts, it is possible to instruct a moving direction of a character or object (player character or player object) that is be operable by a player or instruct the moving direction of a cursor.

The 1 button 26b and the 2 button 26c are respectively push button switches, and are used for adjusting a viewpoint position and a viewpoint direction on displaying the 3D game image, i.e. a position and an image angle of a virtual camera. Alternatively, the 1 button 26b and the 2 button 26c can be used for the same operation as that of the A-button 26d and the B-trigger switch 26i or an auxiliary operation.

The A-button switch 26d is the push button switch, and is used for causing the player character or the player object to take an action other than that instructed by a directional instruction, specifically arbitrary actions such as hitting (punching), throwing, grasping (acquiring), riding, and jumping, etc. For example, in an action game, it is possible to give an instruction to jump, punch, move a weapon, and so forth. Also, in a roll playing game (RPG) and a simulation RPG, it is possible to instruct to acquire an item, select and determine the weapon and command, and so forth.

The − button 26e, the HOME button 26f, the + button 26g, and the power supply switch 26h are also push button switches. The − button 26e is used for selecting a game mode. The HOME button 26f is used for displaying a game menu (menu screen). The +button 26g is used for starting (re-starting) or pausing the game. The power supply switch 26h is used for turning on/off a power supply of the game apparatus 12 by remote control.

In this embodiment, note that the power supply switch for turning on/off the controller 22 itself is not provided, and the controller 22 is set at on-state by operating any one of the switches or buttons of the input means 26 of the controller 22, and when not operated for a certain period of time (30 seconds, for example) or more, the controller 22 is automatically set at off-state.

The B-trigger switch 26i is also the push button switch, and is mainly used for inputting a trigger such as shooting and designating a position selected by the controller 22. In a case that the B-trigger switch 26i is continued to be pushed, it is possible to make movements and parameters of the player object constant. In a fixed case, the B-trigger switch 26i functions in the same way as a normal B-button, and is used for canceling the action determined by the A-button 26d.

As shown in FIG. 3 (E), an external expansion connector 22b is provided on a back end surface of the housing 22a, and as shown in FIG. 3 (B), and an indicator 22c is provided on the top surface and the side of the back end surface of the housing 22a. The external expansion connector 22b is utilized for connecting another expansion controller not shown. The indicator 22c is made up of four LEDs, for example, and shows identification information (controller number) of the lighting controller 22 by lighting any one of the four LEDs, and shows the remaining amount of power of the controller 22 depending on the number of LEDs to be emitted.

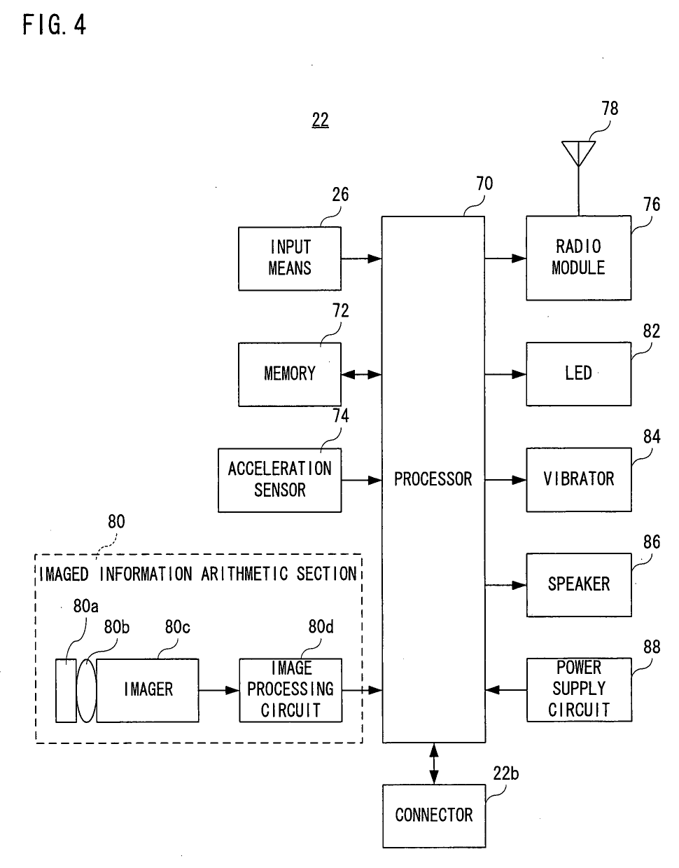

In addition, the controller 22 has an imaged information arithmetic section 80 (see FIG. 4), and as shown in FIG. 3 (A), on the front end surface of the housing 22a, light incident opening 22d of the imaged information arithmetic section 80 is provided. Furthermore, the controller 22 has a speaker 86 (see FIG. 4), and the speaker 86 is provided inside the housing 22a at the position corresponding to a sound release hole 22e between the 1 button 26b and the HOME button 26f on the tope surface of the housing 22a as shown in FIG. 3 (B).

Note that as shown in FIG. 3 (A) to FIG. 3 (E), the shape of the controller 22 and the shape, number and setting position of each input means 26 are simply examples, and needless to say, even if they are suitably modified, the present invention can be realized.

FIG. 4 is a block diagram showing an electric configuration of the controller 22. Referring to FIG. 4, the controller 22 includes a processor 70, and the processor 70 is connected with the external expansion connector 22b, the input means 26, a memory 72, an acceleration sensor 74, a radio module 76, the imaged information arithmetic section 80, an LED 82 (the indicator 22c), an vibrator 84, a speaker 86, and a power supply circuit 88 by an internal bus (not shown). Moreover, an antenna 78 is connected to the radio module 76.

The processor 70 is in charge of an overall control of the controller 22, and transmits (inputs) information (input information) inputted by the input means 26, the acceleration sensor 74, and the imaged information arithmetic section 80 as input data, to the game apparatus 12 via the radio module 76 and the antenna 78. At this time, the processor 70 uses the memory 72 as a working area or a buffer area.

An operation signal (operation data) from the aforementioned input means 26 (26a to 26i) is inputted to the processor 70, and the processor 70 stores the operation data once in the memory 72.

Moreover, the acceleration sensor 74 detects each acceleration of the controller 22 in directions of three axes of vertical direction (y-axial direction), lateral direction (x-axial direction), and forward and rearward directions (z-axial direction). The acceleration sensor 74 is typically an acceleration sensor of an electrostatic capacity type, but the acceleration sensor of other type may also be used.

For example, the acceleration sensor 74 detects the accelerations (ax, ay, and az) in each direction of x-axis, y-axis, z-axis for each first predetermined time, and inputs the data of the acceleration (acceleration data) thus detected in the processor 70. For example, the acceleration sensor 74 detects the acceleration in each direction of the axes in a range from −2.0 g to 2.0 g (g indicates a gravitational acceleration. The same thing can be said hereafter.) The processor 70 detects the acceleration data given from the acceleration sensor 74 for each second predetermined time, and stores it in the memory 72 once. The processor 70 creates input data including at least one of the operation data, acceleration data and marker coordinate data as described later, and transmits the input data thus created to the game apparatus 12 for each third predetermined time (5 msec, for example).

In this embodiment, although omitted in FIG. 3 (A) to FIG. 3 (E), the acceleration sensor 74 is provided inside the housing 22a and in the vicinity on the circuit board where the cross key 26a is arranged.

It will be appreciated by those skilled in the art from the description of this specification that a computer, such as a processor (CPU 40, for example) of the game apparatus 12 or the processor (processor 70, for example) of the controller 22 executes processing on the basis of an acceleration signal output from the acceleration sensors 74, and whereby, more information relating to the controller 22 can be estimated or calculated (determined).

In a case that processing is executed on the side of the computer assuming that the controller 22 incorporated with the single axis acceleration sensor 74 is in a static state, that is, processing is executed considering that accelerations detected by the acceleration sensor 74 is only gravitational accelerations, if the controller 22 is actually in a static state, it is possible to know whether or not the orientations of the controller 22 is inclined with respect to the direction of gravity or to what extent they are inclined on the basis of the detected acceleration. More specifically, when a state in which the detection axis of the acceleration sensor 74 is directed to a vertically downward direction is taken as a reference, merely whether or not 1G (gravitational acceleration) is imposed on can show whether or not the controller 22 is inclined, and the size can show to what extent it is inclined.

Furthermore, if a multi-axes acceleration sensor 74 is applied, by further performing processing on an acceleration signal of each axis, it is possible to more precisely know to what extent the controller 22 is inclined with respect to the direction of gravity. In this case, on the basis of outputs from the acceleration sensor 74, the processor 70 may perform processing of calculating data of inclined angle of the controller 22, but perform processing of estimating an approximate inclination on the basis of the outputs from the acceleration sensor 74 without performing the processing of calculating the data of the inclined angle. Thus, by using the acceleration sensor 74 in conjunction with the processor 70, it is possible to determine an inclination, an orientation or a position of each of the controller 22.

On the other hand, assuming that the acceleration sensor 74 are in a dynamic state, accelerations according to the movement of the acceleration sensor 74 is detected in addition to the gravitational acceleration component, and therefore, if the gravitational acceleration component is removed by predetermined processing, it is possible to know a moving direction, etc. More specifically, in a case that the controller 22 being furnished with the acceleration sensor 74 is accelerated and moved by the hand of the user, acceleration data generated by the acceleration sensor 74 is processed, and whereby, it is possible to calculate various movements and/or positions of the controller 22.

Additionally, even when assuming that the acceleration sensor 74 is in a dynamic state, if an acceleration in correspondence with the movement of the acceleration sensor 74 is removed by the predetermined processing, it is possible to know the inclination with respect to the direction of gravity. In another embodiment, the acceleration sensor 74 may contain a built-in signal processing apparatus or other kinds of dedicated processing apparatuses for performing desired processing on the acceleration signal (acceleration data) output from the incorporated acceleration detecting means before outputting the acceleration signal to the processor 70. For example, in a case that the acceleration sensor 74 is one for detecting a static acceleration (gravitational acceleration, for example), the built-in or dedicated processing apparatuses may be one for transforming the detected acceleration signal into the inclined angle (or other preferable parameters) corresponding thereto.

The radio module 76 modulates a carrier of a predetermined frequency by the input data, by using a technique of Bluetooth, for example, and emits its weak radio wave signal from the antenna 78. Namely, the input data is modulated to the weak radio wave signal by the radio module 76 and transmitted from the antenna 78 (controller 22). The weak radio wave signal thus transmitted is received by the radio controller module 52 provided to the aforementioned game apparatus 12. The weak radio wave thus received is subjected to demodulating and decoding processing. This makes it possible for the game apparatus 12 (CPU 40) to acquire the input data from the controller 22. Then, the CPU 40 performs game processing, following the input data and the program (game program).

In addition, as described above, the controller 22 is provided with the imaged information arithmetic section 80. The imaged information arithmetic section 80 is made up of an infrared rays filter 80a, a lens 80b, an imager 80c, and an image processing circuit 80d. The infrared rays filter 80a passes only infrared rays from the light incident from the front of the controller 22. As described above, the markers 340m and 340n placed near (around) the display screen of the monitor 34 are infrared LEDs for outputting infrared lights forward the monitor 34. Accordingly, by providing the infrared rays filter 80a, it is possible to image the image of the markers 340m and 340n more accurately. The lens 80b condenses the infrared rays passing thorough the infrared rays filter 82 to emit them to the imager 80c. The imager 80c is a solid imager, such as a CMOS sensor and a CCD, for example, and images the infrared rays condensed by the lens 80b. Accordingly, the imager 80c images only the infrared rays passing through the infrared rays filter 80a to generate image data. Hereafter, the image imaged by the imager 80c is called an “imaged image”. The image data generated by the imager 80c is processed by the image processing circuit 80d. The image processing circuit 80d calculates a position of an object to be imaged (markers 340m and 340n) within the imaged image, and outputs each coordinate value indicative of the position to the processor 70 as imaged data for each fourth predetermined time. It should be noted that a description of the process in the image processing circuit 80d is made later.

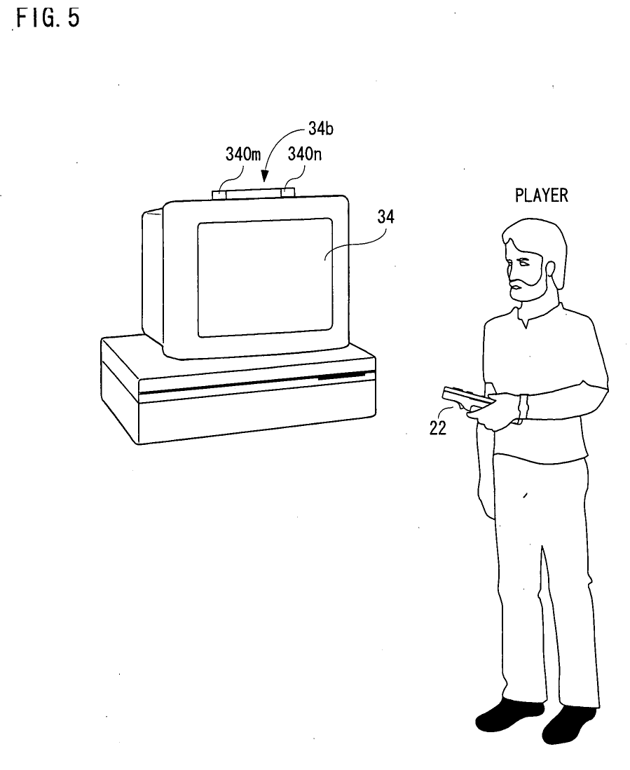

FIG. 5 is an illustrative view summarizing a state when a player plays a game by utilizing a controller 22. As shown in FIG. 5, when playing the game by means of the controller 22 in the video game system 10, the player holds the controller 22 with one hand. Strictly speaking, the player holds the controller 22 in a state that the front end surface (the side of the incident light opening 22d of the light imaged by the imaged information arithmetic section 80) of the controller 22 is oriented to the markers 340m and 340n. It should be noted that as can be understood from FIG. 1, the markers 340m and 340n are placed in parallel with the horizontal direction of the screen of the monitor 34. In this state, the player performs a game operation by changing a position on the screen indicated by the controller 22, and changing a distance between the controller 22 and each of the markers 340m and 340n.

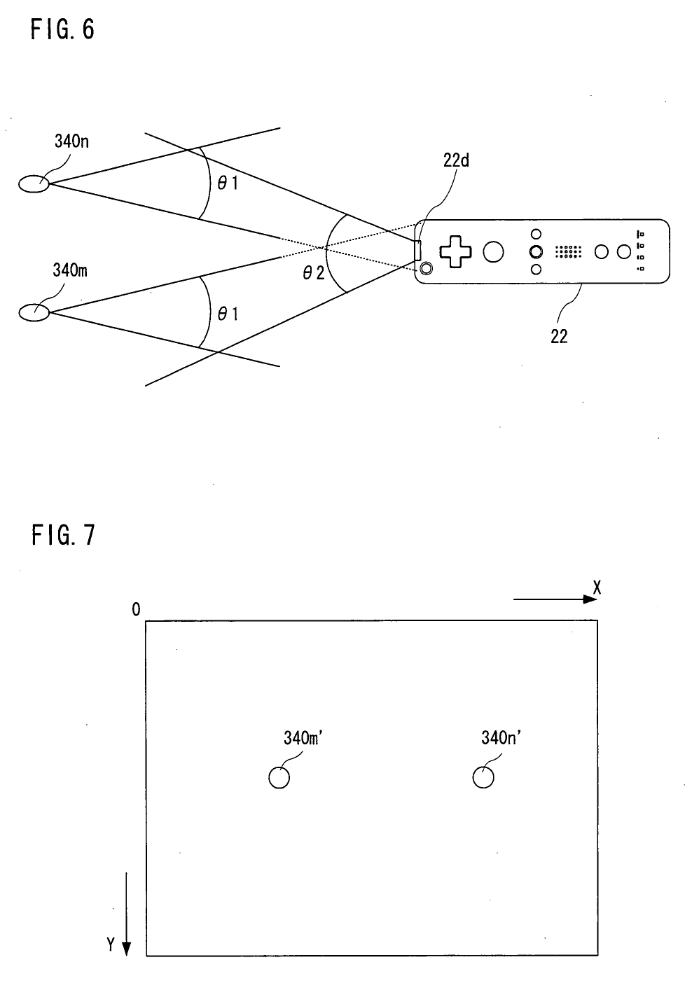

FIG. 6 is a view showing viewing angles between the respective markers 340m and 340n, and the controller 22. As shown in FIG. 6, each of the markers 340m and 340n emits infrared ray within a range of a viewing angle θ1. Also, the imager 80c of the imaged information arithmetic section 80 can receive incident light within the range of the viewing angle θ2 taking the line of sight of the controller 22 as a center. For example, the viewing angle θ1 of each of the markers 340m and 340n is 34° (half-value angle) while the viewing angle θ2 of the imager 80c is 41°. The player holds the controller 22 such that the imager 80c is directed and positioned so as to receive the infrared rays from the markers 340m and 340n. More specifically, the player holds the controller 22 such that at least one of the markers 340m and 340n exists in the viewing angle θ2 of the imager 80c, and the controller 22 exists in at least one of the viewing angles θ1 of the marker 340m or 340n. In this state, the controller 22 can detect at least one of the markers 340m and 340n. The player can perform a game operation by changing the position and the orientation of the controller 22 in the range satisfying the state.

If the position and the orientation of the controller 22 are out of the range, the game operation based on the position and the orientation of the controller 22 cannot be performed. Hereafter, the above-described range is called an “operable range.”

If the controller 22 is held within the operable range, an image of each of the markers 340m and 340n is imaged by the imaged information arithmetic section 80. That is, the imaged image obtained by the imager 80c includes an image (object image) of each of the markers 340m and 340n as an object to be imaged. FIG. 7 is a view showing one example of the imaged image including an object image. The image processing circuit 80d calculates coordinates (marker coordinates) indicative of the position of each of the markers 340m and 340n in the imaged image by utilizing the image data of the imaged image including the object image.

Since the object image appears as a high-intensity part in the image data of the imaged image, the image processing circuit 80d first detects the high-intensity part as a candidate of the object image. Next, the image processing circuit 80d determines whether or not the high-intensity part is an object image on the basis of the size of the detected high-intensity part. The imaged image may include images other than the object image due to sunlight through a window and light of a fluorescent lamp in the room as well as the images 340m′ and 340n′ of the two markers 340m and 340n as an object image. The determination processing whether or not the high-intensity part is an object image is executed for discriminating the images 340m′ and 340n′ of the two markers 340m and 340n as an object image from the images other than them, and accurately detecting the object image. More specifically, in the determination process, it is determined whether or not the detected high-intensity part is within the size of the preset predetermined range. Then, if the high-intensity part is within the size of the predetermined range, it is determined that the high-intensity part represents the object image. On the contrary, if the high-intensity part is not within the size of the predetermined range, it is determined that the high-intensity part represents the images other than the object image.

In addition, as to the high-intensity part which is determined to represent the object image as a result of the above-described determination processing, the image processing circuit 80d calculates the position of the high-intensity part. More specifically, the barycenter position of the high-intensity part is calculated. Here, the coordinates of the barycenter position is called a “marker coordinate”. Also, the barycenter position can be calculated with more detailed scale than the resolution of the imager 80c. Now, the resolution of the imaged image imaged by the imager 80c shall be 126×96, and the barycenter position shall be calculated with the scale of 1024×768. That is, the marker coordinate is represented by the integer from (0, 0) to (1024, 768).

Additionally, the position in the imaged image shall be represented by a coordinate system (XY coordinate system) taking the upper left of the imaged image as an origin point, the downward direction as an Y-axis positive direction, and the right direction as an X-axis positive direction.

Also, if the object image is properly detected, two high-intensity parts are determined as an object image by the determination process, and therefore, two marker coordinates are calculated. The image processing circuit 80d outputs data indicative of the calculated two marker coordinates. The data (marker coordinate data) of the output marker coordinates is included in the input data by the processor 70 as described above, and transmitted to the game apparatus 12.

The game apparatus 12 (CPU 40) detects the marker coordinate data from the received input data to thereby calculate an instructed position (instructed coordinate) by the controller 22 on the screen of the monitor 34 and a distances from the controller 22 to each of the markers 340m and 340n on the basis of the marker coordinate data. More specifically, from the position of the mid point of the two marker coordinates, a position to which the controller 22 faces, that is, an instructed position is calculated. The distance between the object images in the imaged image is changed depending on the distance between the controller 22 and each of the markers 340m and 340n, and therefore, the game apparatus 12 can grasp the distance between the controller 22 and each of the markers 340m and 340n by calculating the distance between the two marker coordinates.

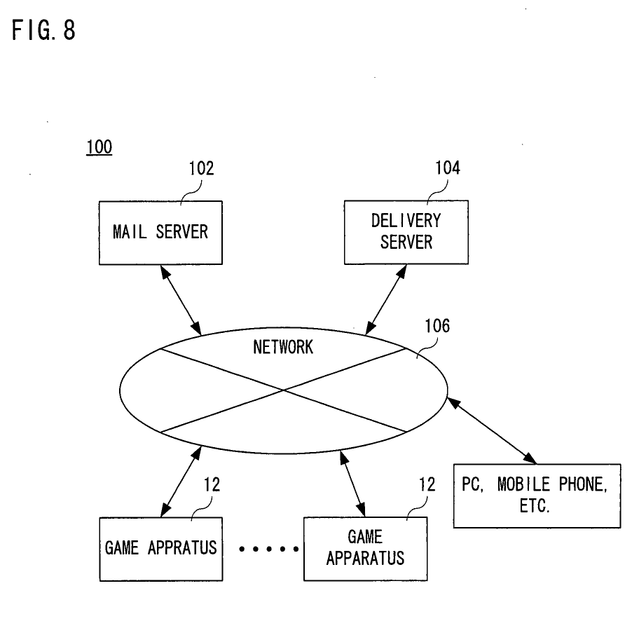

An outline of transmitting and receiving messages in accordance with one embodiment of the present invention is explained below. FIG. 8 is an illustrative view showing one example of a communication system 100 (questionnaire answer system) utilizing the above-described game apparatus 12. As shown in FIG. 8, the communication system 100 includes a plurality of game apparatuses 12, and each of the game apparatuses 12 is connected to a mail server 102 and a delivery server 104 via a network 106 like the Internet and a LAN. By being connected to such the network 106, it becomes possible to perform transmitting and receiving of messages via the mail server 102 and download of data from the delivery server 104.

It should be noted that although a description is made on a case that a plurality of game apparatuses 12 are connected to the network 106 in this embodiment, one game apparatus 12 is appropriate. Furthermore, a plurality of delivery servers 104 may be provided depending on the kind of the download data (content). In addition, the network 106 is also connected with a PC, and a cellular phone via a cellular phone network. Other various electronical appliances can be connected to the network 106 to perform transmitting and receiving of messages with the game apparatus 12 via the mail server 102.

The game apparatuses 12 are capable of communicating with each other via the network 106. A message input by a player and a message generated by a game apparatus 12 are transformed into an electronic mail format so as to be transmitted and received (exchanged) between the game apparatuses 12 via the network 106 and the mail server 102. Thus, as a mail server 102, it is possible to use versatile mail servers. Also, the game apparatus 12 can transmit and receive messages, i.e., electronic mails with terminals (terminal except for other game apparatuses 12), such as a PC, a cellular phone. Such message transmitting and receiving process in the game apparatus 12 is automatically executed according to a predetermined schedule without the user issuing a transmitting and receiving instruction, and therefore, the user can play a game or other applications with a message held without periodically checking the mail by itself. Furthermore, the game apparatus 12 can perform transmitting and receiving of messages only with a game apparatus 12 or other terminals except for the game apparatus 12 (hereinafter, simply referred to as “other terminal”) whose destination is registered in the address book (friend list 44d described later), which prevents the user from receiving unnecessary messages like a spam even by utilizing versatile mail systems.

The game apparatus 12 can execute a message board function being an application for displaying the received message on the monitor 34. The message specific to the other application (game, etc.) and the data to be utilized by only the application are made readable in only the application. Thus, in a case that a message has to be transmitted to only the specific user, if data dependent on an individual application is included in the message and transmitted, it can be made in a format unreadable by the message board function. However, irrespective of the kind of the application, a referable message is displayed by the message board function on the monitor 34 so as to be referred (read) by anyone.

The message board function is an application having a function to display a received message on the monitor 34, and displays a message acquired from the network 106. Additionally, a message created for the user himself as well as the message received from other game apparatuses 12 and other terminals can similarly be displayed. Therefore, in a case that the game apparatus 12 is not connected to the network 106, the message board function can be used as a message board for home use and a personal note pad, and a record created by an application like a game, etc. can be browsed by the message board function afterward. At this time, if the message created in the game apparatus 12 is stored in a format similar to that of the message acquired from the network 106 (electronic mail format in the embodiment) in the same area, there is no need to separately prepare processing for display. For example, at a time of creating notes or messages, data is converted into data in an electronic mail format, or in the game program processing, data in an electronic mail format may be created.

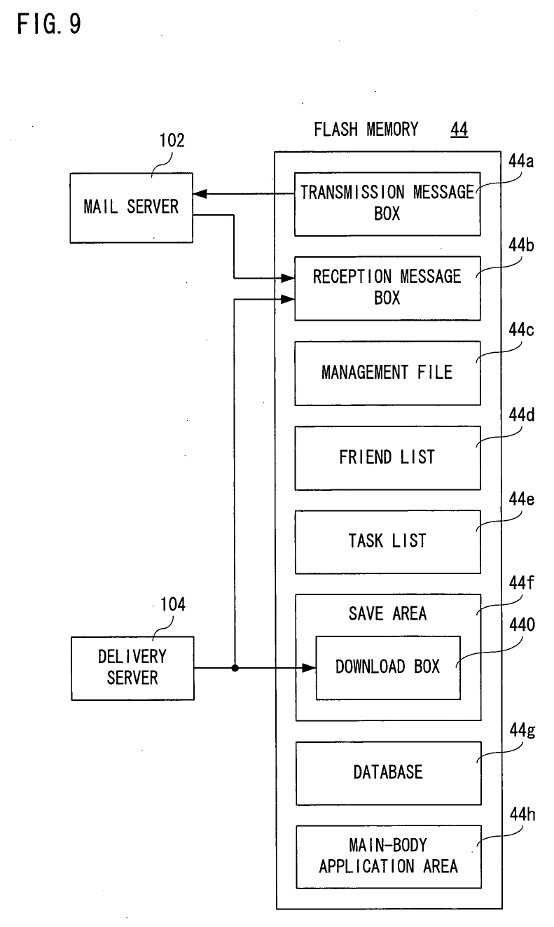

FIG. 9 is an illustrative view diagrammatically showing a configuration of data stored in the flash memory 44 integrated in the game apparatus 12. By utilizing FIG. 9, the outline of a message transmitting and receiving process and a download process in this embodiment are explained. The game apparatus 12 performs transmitting and receiving of messages with the mail server 102, and downloading data from the delivery server 104. That is, the game apparatus 12 performs two kinds of the communication processing. The message transmitting and receiving process and the download process are executed by the input-output processor 42a. The flash memory 44 includes a transmission message box 44a, a reception message box 44b, a management file 44c, a friend list 44d, a task list 44e, a save area 44f, a database 44g, and a main-body application area 44h as a memory area.

The transmission message box 44a is an area for storing a message in an electronic mail format (regarding as transmission data) to other game apparatus 12 and other terminal from the game apparatus 12. As understood from FIG. 9, the transmission data is transmitted to the mail server 102. Accordingly, the game apparatus 12 can transmit a message to other game apparatus 12 via the mail server 102 and the network 106. The input-output processor 42a referrers to the transmission message box 44a on the basis of a predetermined schedule (every ten minutes, for example), and transmits, if transmission data is stored, the stored transmission data to the network 106. When the transmission data is transmitted to the network 106, the transmission data is deleted from the transmission message box 44a.

Thus, since the transmission of the electronic mail is performed independent of an application by the input-output processor 42a, in the application executed by the CPU 40, such as the message board function, the game, etc., by merely performing processing of creating a message and then recording the message in an electronic mail format in the transmission message box 44a, it is possible to transmit the message to the network.

It should be noted that in this embodiment, more versatile data in an electronic mail format is transmitted and received with a mail server, but the data is not limited to the electronic mail format, and can be diverted for various formats. Especially, in a case that communication is limited to the communication between the game apparatuses 12, there is no need to be a versatile format. Even in a case of being communicated with other terminal, a versatile format executable in the terminal would be adopted. Furthermore, the kind of the server may be a kind of server except for the mail server may be provided only that it has a feature of holding data from a terminal until being accessed.

Furthermore, in a case that a transmission function is stopped for some reason, or in a case that a communication failure occurs, transmitting the transmission data is not performed, and an excess volume of data in the transmission message box 44a may occur. In such a case, registering the transmission message in the transmission message box 44a is not accepted.

The reception message box 44b is an area for storing a message in an electronic mail format (may be referred to as a “reception data” in contrast to the “transmission data” in this embodiment) received from other game apparatus 12, other terminal, and the delivery server 104. As understood from FIG. 9, the reception data is transmitted from the mail server 102 and the delivery server 104. The input-output processor 42a accesses the mail server 102 on the basis of a predetermined schedule (for every ten minutes, for example) to confirm whether or not a new arriving e-mail is present in the server, and if the new arriving e-mail is present, the new arriving e-mail is received so as to be stored in the reception message box 44b as reception data. In the reception message box 44b, the reception data is held until it is opened (utilized) and deleted by an application, or the reception message box 44b is full. It should be noted that when the reception message box 44b becomes full, every time that new reception data is received, the reception data is deleted from the oldest one. In a case that the game apparatus 12 is in a normal mode, the reception data held in the reception message box 44b is moved to a database 44g according to the header information except for one attached with the data depending on an application, such as game data, and is readable by the message board function.

It should be noted that the reception data from the mail server 102 is a message from other game apparatus 12 and other terminal. The reception data from the delivery server 104 is a message like a notice to a plurality of users from an administrator, etc. of the delivery server 104. For example, from the administrator, etc. of the delivery server 104, a message, such as information of the latest game application (game software) and information of an event in the game are transmitted (notified). A detailed description of storing data received from the delivery server 104 in the reception message box 44b is made later.

The management file 44c is management information on the game apparatus 12, and stores information specific to the game apparatus 12, such as the identification information of the game apparatus 12, a profile of the user, etc. so as to be read as necessary. The friend list 44d corresponds to the so-called address book of the electronic mail to which identification information of the registered other game apparatus 12 (or e-mail address) and an e-mail address of other terminal are described. The friend list 44d can be referred from various applications are executed as well as in a case that message board function is executed. It should be noted that out of identification information of other game apparatuses 12 and e-mail address of other terminals described in the friend list 44d, electronic mail (reception data) except for one that transmitted from the game apparatus 12 with the identification information and other terminal with the e-mail address which is subjected to a friend registration (address registration) is deleted. That is, if the transmission source is unidentified, the reception data is filtered. This makes it possible to automatically delete an undesired electronic mail like a spam.

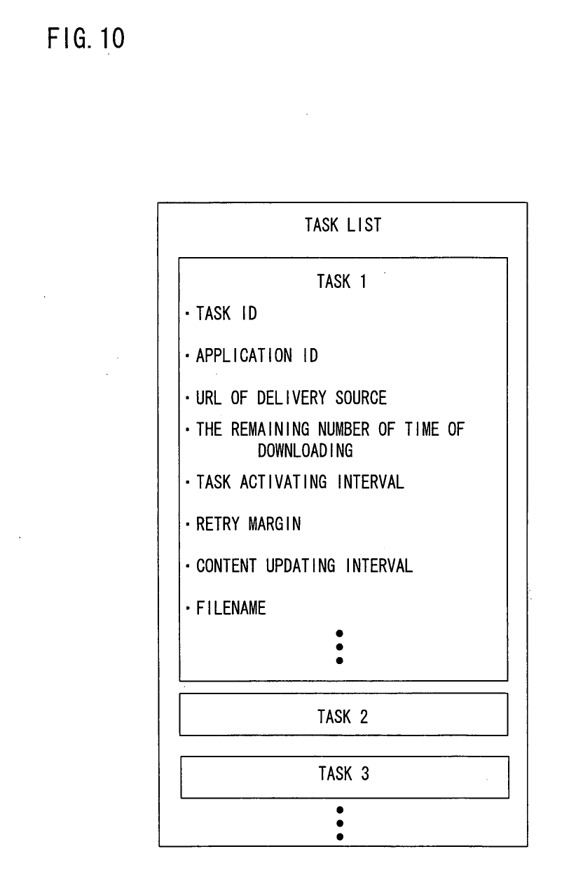

The task list 44e is a list of tasks representing a schedule for downloading data from the delivery server 104, and stores a task registered in advance for the game apparatus 12 and a task arbitrarily registered by the user. Each of the tasks is executed to allow execution of the download process. It should be noted that in this embodiment one task can be registered in one application. FIG. 10 shows one example of attribute information included in each task. One task includes identification information of a task (task ID), identification information of an application (application ID), an URL of a delivery source, the remaining number of times of downloading, a task activating interval, a retry margin, a content updating interval, and a file name.

The task ID is an ID for uniquely identifying a task. The application ID is an ID for uniquely identifying an application in which a task is registered. The application ID is determined in correspondence with the application which performs a task registering process.

The URL of the delivery source indicates the place of the delivery source (delivery server 104), and includes a file name of the download data. The URL of the delivery source is set by the user, and automatically set by the application.

The remaining number of times of downloading indicates a download executable count. In this embodiment, when the game apparatus 12 (input-output processor 42a) transmits a connection request (request) to the network 106 (delivery server 104) for downloading, the remaining number of times of downloading is generally subtracted by 1. Then, when the remaining number of times of downloading is 0, the task is deleted from the task list 44e to make the task unexecutable. By setting the remaining number of times of downloading, it is possible to perform downloading at a necessary time, capable of preventing useless download process from continuously being executed even when the download is not needed.

The task activating interval is a time interval of executing a task, and specifically means a time (period) from execution of a task to execution of a next task. It should be noted that at a time of a task being registered, a next task executable time is determined by taking the registered time as a reference. The task activating interval is set by a user, and automatically set in correspondence with the kind of the download data (content).

The retry margin is an allowable time when an executing time (estimated time) of the next task determined by an interval of activating the download can be delayed. For example, in a case that the power of the game apparatus 12 is completely turned off, in a case that a failure occurs to the network, and so forth, the task cannot be executed and an estimated time of the task may be missed in a case that a next task executable state come. Furthermore, in a case that the estimated time is significantly delayed, the data to be downloaded itself may already be unneeded. Thus, at a time of registering the task, the retry margin is set. When an estimated time is determined in correspondence with the task activating interval, a retry allowable hour (retry allowed hour) is determined in correspondence with the retry margin. When the retry allowable hour expires, the task is not executed, and then deleted from the task list 44e. The retry margin is set by a user, and automatically set depending on the kind of the download data.

The content updating interval is an average value of the intervals for updating a content (download data) to be set in the delivery source concerning the URL of the delivery source. Thus, depending on the kind of the download data, taking the average value of the intervals for updating the download data indicated by the content activating interval into consideration, the task activating interval is set. More specifically, if the task activating interval is set to be longer than the content updating interval, useless downloading like acquiring the same download data again can be eliminated. On the contrary thereto, if the task activating interval is set to be shorter than the content updating interval, missing the download of the content to be updated can be eliminated. The average value of the update intervals may be a value presumed in advance, and in order to update the task, the average value of the update intervals is acquired from the delivery server 104 every time that the download is executed so as to update the task.

The file name is a file name applied when the download data is stored, and can be designated by an option, for example. It should be noted that the download data is attached with a file name, and therefore, data with a predetermined file name can be acquired without designating the file name.

It should be noted that a detailed description is made on execution of the task. The download data can be used in the application indicated by the identification information (application ID). For example, in the game application, the download data is data like an addition map, an addition character, an addition item, etc. as to the game.

Returning to FIG. 9, the save area 44f is an area storing (saving) data of an application, and includes a download box 440 within the area. The download box 440 is an area to store download data downloaded from the delivery server 104 according to a task as described above. Although detailed description is omitted, an application ID for identifying the application registering a task is applied to the download data in advance. It should be that the application ID is not necessarily applied to the download data in advance, and in another embodiment, when the application ID is registered in the download box 440, the application ID indicated by the attribute of the task is referred so as to be applied. Thus, in a case that download data of various kinds of the applications is stored in the download box 440, it is possible to identify each download data by the application ID. Furthermore, the save area 44f ensures an area for each application. Thus, in another embodiment, a download box for each application may be provided in the area for storing application data corresponding to the download data.

The database 44g is an area for storing a message utilized in the above-described message board function for each date, and can be referred from other application. As described above, the reception data is stored in the reception message box 44b, but since the capacity of the reception message box 44b is limited, when the reception message box 44b is full, the reception data is deleted from the oldest one. Accordingly, the database 44g is provided for storing a message for a long time and for sharing the message, and the reception data (message) except for one utilized in the individual application, such as one attached with game data is moved to the database 44g from the reception message box 44b. At this time, the header information of the message is referred so as to be stored in each area of the database 44g managed for each date. For example, if a year, month and day, and time are described as information of the message board date and time designation, the reception data is stored in the area corresponding to the designated year, month and day. However, if the header information of a message is not designated by a date and time, etc., the message is stored in the area corresponding to the date when the message is received. The managing method of an area for each date is only necessary to set a folder for each day and store the message in corresponding folder, for example. Furthermore, the file name at a time of storage may be a file name representing an hour.

Although illustration is omitted, in a case that a memory card is attached to the connector for memory card 62, the content of the database 44g can be backed up in the memory card automatically or in accordance with an instruction by the user.

The main-body application area 44h is an area for storing a program (software) of an application incorporated as a main body function. For example, applications of the function (main body function) of the game apparatus 12 itself, such as a menu program at a time of activating the game apparatus 12, a message board function, a friend registration function are stored (installed) in the main-body application area 44h. That is, the game apparatus 12 is a game apparatus which is able to read a program of a game, etc. stored in the optical disk 18 to execute the application, and read a program stored in the flash memory 44 to execute the application. Furthermore, as a, the above-described software can be added to the program to be stored in the main-body application area 44h.

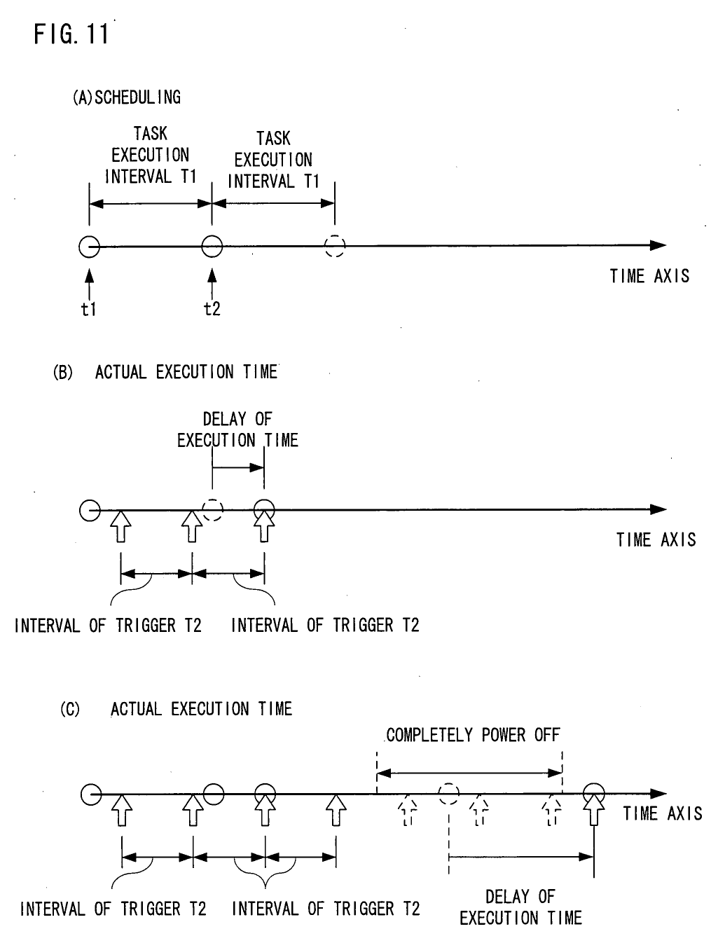

Now, an outline of the download process to be executed by the input-output processor 42a is explained. In this embodiment, the download data is acquired from the delivery server 104. As shown in FIG. 11 (A), if a certain task is registered in the task list 44e, the task is scheduled by taking a current time t1 as a reference. For example, in the example shown in FIG. 11 (A), scheduling of the task is executed at a time (estimated time) t2 in accordance with an execution interval T1 of the task. Additionally, the execution time T1 corresponds to the task activating interval of the attribute information of the task. The time can be obtained from the ROM/RTC 48. When the task is executed, a next task is executed at the estimated time adding the execution time T1 to the executing time. The downloading task decrements the remaining number of times of downloading by one when a downloading is executed. At this time, a scheduling of an estimated time (execution estimated time) when the next task is executed is made.

As shown in FIG. 11 (B), inside the input-output processor 42a, a trigger is generated every predetermined time per unit of time of the processing, and at a time of generating a trigger, processing of comparing a trigger generation time, and the afore-stated estimated time of transmitting and receiving of messages and an estimated time of downloading, etc. is performed. If the estimated time expires, the processing is activated. Thus, if the scheduling of the task is set after the trigger generation, the task is executed at the next trigger generation, and therefore, an actual executing time of the task may slightly be delayed from the estimated time t2 set in FIG. 11 (A).

Furthermore, as shown in FIG. 11 (C), execution of the task itself may be stopped similar to a case that the power of the game apparatus 12 is completely off unlikely to the standby mode. In such a case, the task is executed after the game apparatus 12 is activated again, but a long-delay of an executing time of the task may occur.

Additionally, execution of the task can temporarily be stopped or restarted in accordance with the request from an application, and in such a case also, a delay of an executing time of the task may occur.

If a delay of an executing time of the task occurs, the data to be downloaded may be already useless. Therefore, if a delay occurs, a retry margin is set for determining whether or not the execution of the task is allowed as attribute information of the task. More specifically, when a task is executed, it is determined whether or not timing when the execution of the task is started (current hour) is past a retry allowable time which is obtained by adding a time indicated by a retry margin to the estimated time of the task execution. Then, if the current time is past the retry allowable time, the task execution is not performed, and the task is deleted from the task list 44e. On the other hand, if the current time is before the retry allowable time, the task is executed to continue the following processing.

The game apparatus 12 can execute an application for a questionnaire (questionnaire application), for example. Additionally, the questionnaire application is installed in the game apparatus 12 in advance as an application for the main body, loaded from an optical disk 18, and so fort. Also, a program (application software for the questionnaire) is downloaded from the server like the delivery server 104 so as to be additionally installed in the game apparatus 12.

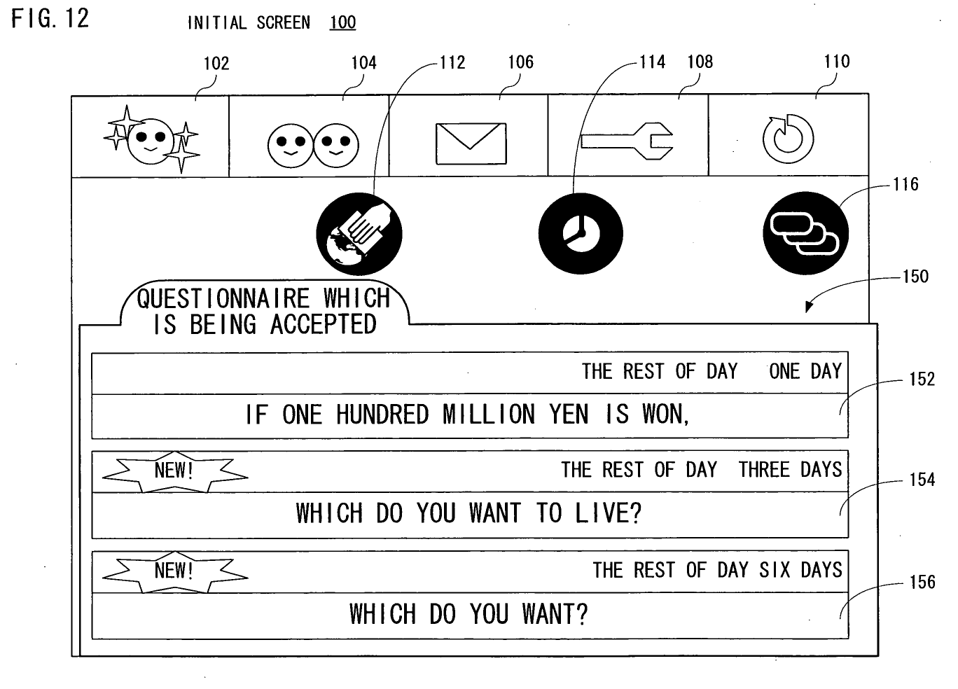

If the questionnaire application is activated, a questionnaire initial screen 100 as shown in FIG. 12 is displayed on the monitor 34. The initial screen 100 is a screen for selecting execution of various processes in the questionnaire application. On the initial screen 100, a plurality of buttons (or icons) 102,104, 106, 108, 110, 112, 114, and 116 are displayed, and a display section (questionnaire display section) 150 for displaying (in list form) a questionnaire which is being accepted is set.

The button 102 is a button for making a new registration (new creation) of a player object used in the questionnaire application. The button 104 is a button for referring to data (player data) as to player objects used in the questionnaire application. The button 106 is a button for generating a message (electronic mail). The button 108 is a button for setting options as to the questionnaire application (all data erasure, region selection, switch of languages, etc.). The button 110 is a button for returning to a menu program screen when the game apparatus 12 is activated. The button 112 is a button for selecting questionnaires (world questionnaire) implemented in all the countries of the world. The button 114 is a button for displaying a result of the questionnaire which is currently being answered. The button 116 is a button for viewing the result of the questionnaire answered in the past.

Furthermore, on the questionnaire display section 150, a plurality of display areas 152, 154 and 156 (three in this embodiment) are provided. In each of the display areas 152, 154 and 156, all or a part of the content of a questionnaire (question) is displayed in a text format, and the answer dead line is displayed. In addition, with respect to a questionnaire newly displayed in the questionnaire display section 150, a message showing that it is newly displayed is displayed in the display area (154 and 156 in FIG. 12). For example, in the example shown in FIG. 12, a character of “NEW!” is displayed by a speech bubble (balloon). This is merely one example, and newness of the display may be represented by changing a color or brightness, or the both thereof of the display areas 152, 154 and 156 without the character being displayed.

In this embodiment, three questionnaires are selectably displayed on the initial screen 100. Although a detailed description is omitted, the questionnaire displayed in the display areas 152, 154 and 156 are managed by storing identification information (described later question ID) of the questionnaires (questions) in a display area provided to the main memory (42e and 46).

Furthermore, such the questionnaire is updated on a relatively long time, and therefore, after a questionnaire is received once, it might take a long time until a next questionnaire is received. In this embodiment, one preliminary questionnaire has been received, and in a case that a questionnaire whose answer dead line expires is erased, the preliminary questionnaire can be read to be displayed. That is, three questionnaires for display and one preliminary questionnaire are stored in the main memory (42e and 46).

It should be noted that two or more preliminary questionnaires may be received. In such a case, in display of the preliminary questionnaire, a questionnaire with the oldest answer dead line is selected to be displayed on the initial screen 100.

Additionally, each of the main memories (42e and 46) are provided with a result wait area, in which a question ID of the questionnaire whose dead line for answer expires is moved from the display area to the result wait area. That is, the questionnaire whose dead line for answer expires is managed in the result wait area for waiting the counting result.

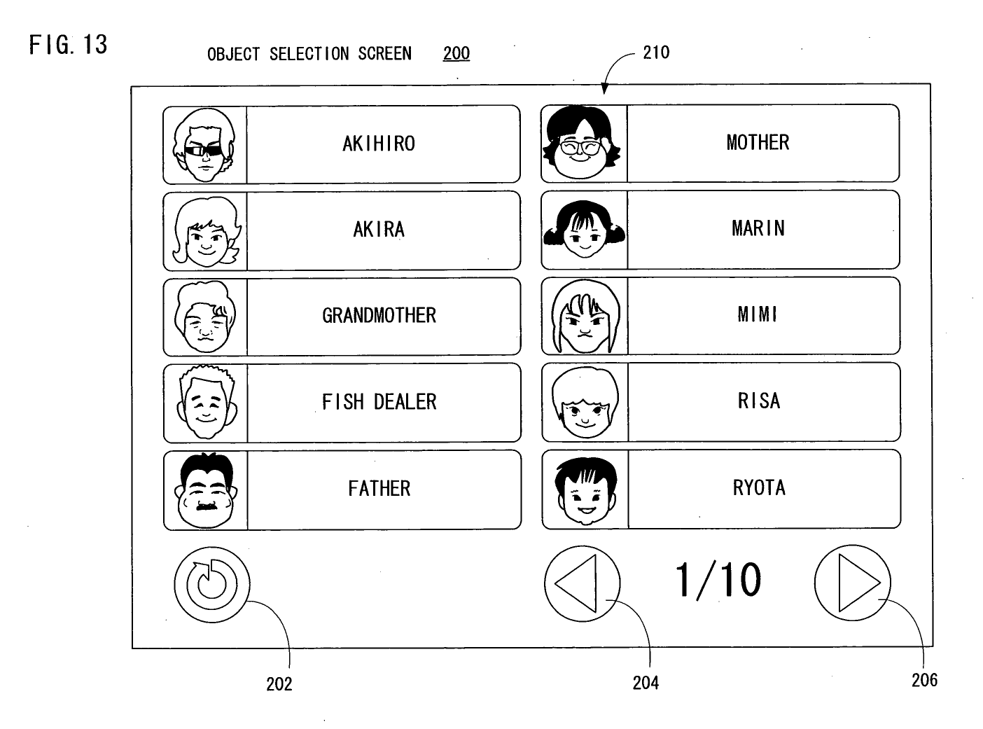

When the button 102 is turned on (clicked) on the initial screen 100, an object selection screen 200 shown in FIG. 13 is displayed on the monitor 34. The object selection screen 200 is a screen for selecting a player object (avatar) used in the questionnaire application. Although a detailed description is omitted, a maximum of six player objects can be used (registered) in this embodiment.

As shown in FIG. 13, on the object selection screen 200, a display section 210 for displaying player objects is provided, in which facial images of a plurality of player objects (ten in FIG. 13) and names of the player objects corresponding to the facial images are displayed. These facial images and names are created by the player, or arbitrarily created by the game apparatus 12 (CPU 40).

Also, on the object selection screen 200, buttons 202, 204 and 206 are provided below the display section 210. The button 202 is a button for returning to the initial screen 100 shown in FIG. 12. The button 204 is a return button. The button 206 is a feed button. For example, in the game apparatus 12, one hundred player objects can be registered (created), so that in response to the player feeding and returning the pages, various player objects are displayed on the display section 210. Thus, the player searches a desired player object, and registers (selects) the desired player object used in the questionnaire application.

It should be noted that whenever the questionnaire application is activated at first, a player object is required to be registered, and therefore, the object selection screen 200 is displayed in place of the initial screen 100.

In addition, the player object which has already been registered is not displayed on the object selection screen 200 or grayed out so as be displayed in an unselectable manner.

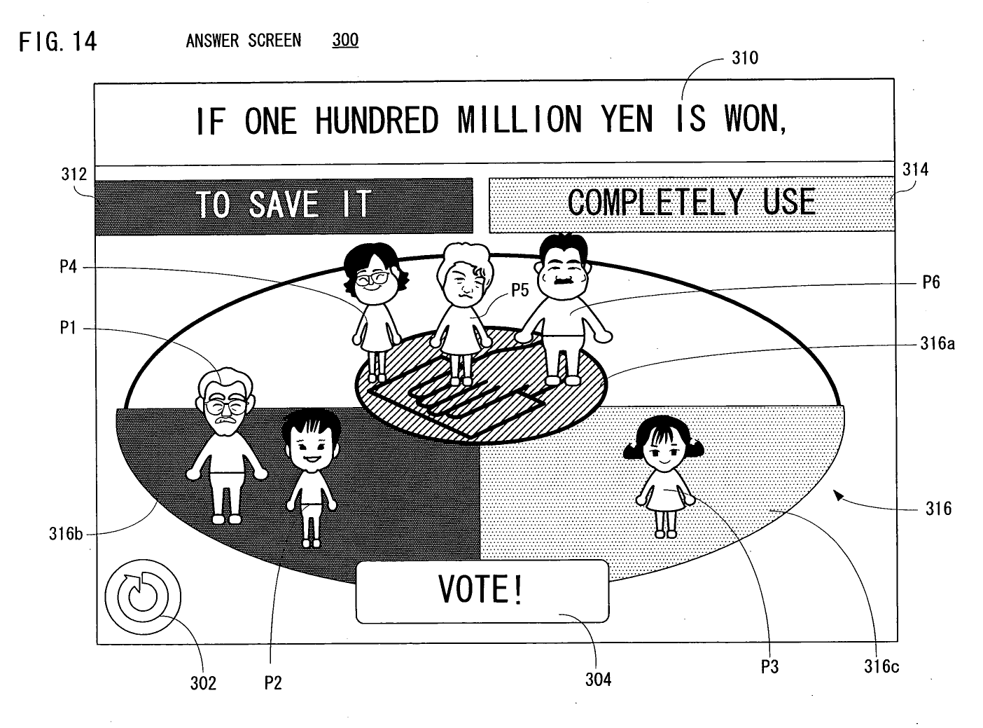

Returning to FIG. 12, when a questionnaire of the display area 152 is selected, an answer screen 300 for answering the questionnaire is displayed on the monitor 34 as shown in FIG. 14. On the answer screen 300, a display area 310 for displaying a content of a questionnaire (question), a display area 312 for displaying a content of a first answer to the question, and a display area 314 for displaying a content of a second answer to the question are displayed. For convenience of explanation, these are called a first answer display area 312 and a second answer display area 314. In FIG. 14 example, a question “If one hundred million yen is won” is displayed on the display area 310, an answer “saving it” is displayed in the first answer display area 312, and an answer “spending completely” is displayed in the second answer display area 314.

Also, on the answer screen 300, a selection area 316 for selecting an answer to the questionnaire is provided. The selection area 316 includes an area 316a where no answer is selected (not-yet-selected area), an area 316b for selecting a first answer (first answer selection area), and an area 316c for selecting a second answer (second answer selection area).

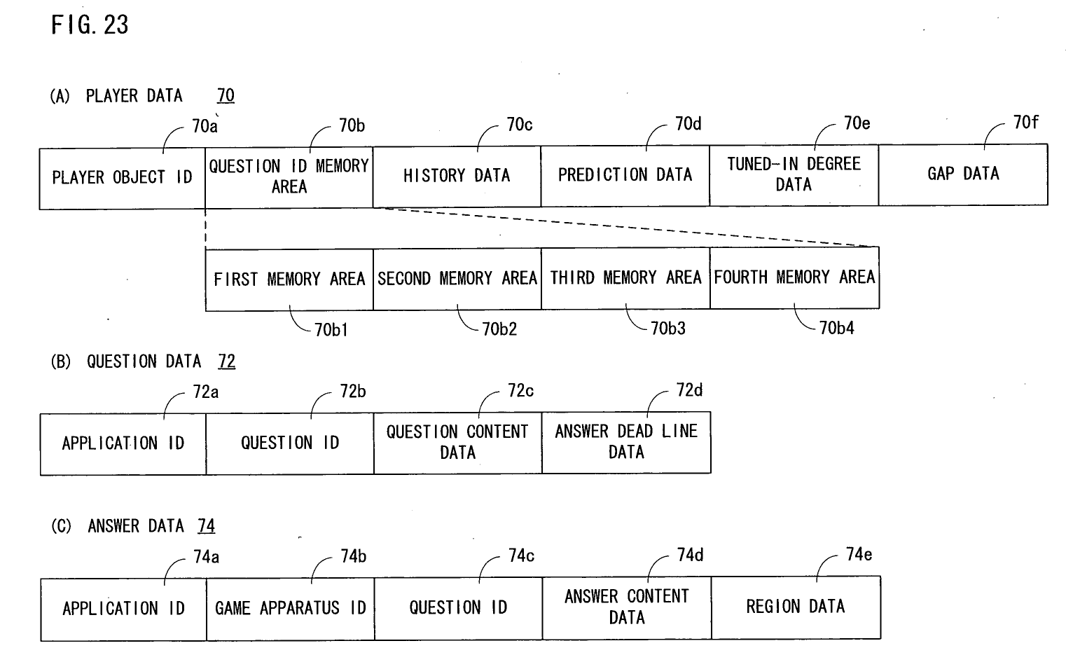

In addition, on the answer screen 300, a button 302 and a button 304 are provided. The button 302 is a button for returning to the initial screen 100. The button 304 is a button for voting an answer to a questionnaire. More specifically, when the button 304 is turned on, answer data (see FIG. 23 (C)) of the answer result of the questionnaire is sent to a server (delivery server 104 in this embodiment) for collecting and counting the answers to the questionnaire as described later.

For example, the player drags and moves a player object (P1, P2, P3, P4, P5, and P6) displayed in the not-yet-selected area 316a to the first answer selection area 316b or the second answer selection area 316c. Although illustration is omitted, before voting an answer to the questionnaire, the player can freely move the player object between the first answer selection area 316b and the second answer selection area 316c.

However, once an answer to the questionnaire is voted, when the answer screen 300 as to the questionnaire is displayed at the next time, the player object which has answered the questionnaire is grayed out in the selection area (316a and 316b) where the player object made the answer.

The reason why the answer screen 300 is also displayed after the vote of the questionnaire is that any one of the player objects (P1-P6) which has not voted yet exists, or the content of the voting by the player is required to be confirmed.

Although a detailed description is omitted, data as to a questionnaire (question data described later: see FIG. 23 (B)) is delivered by a server collecting and counting the answers to the questionnaire, or delivered by other servers. In this embodiment, the delivery server 104 delivers the question data.

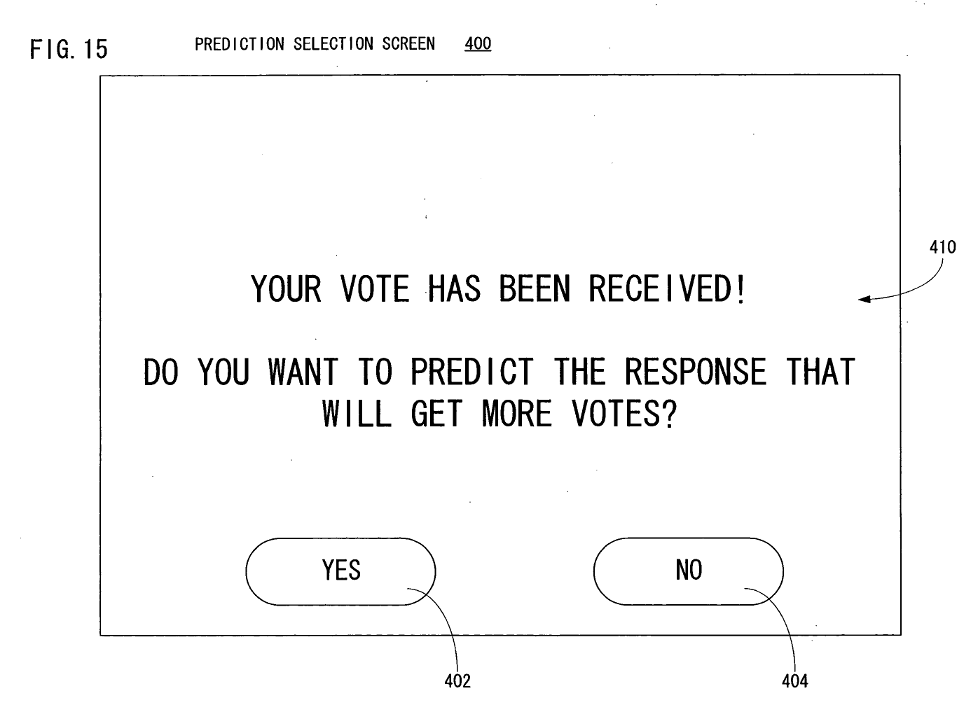

Furthermore, when the button 304 is turned on to vote against the questionnaire on the answer screen 300 shown in FIG. 14, a prediction selection screen 400 shown in FIG. 15 is displayed on the monitor 34. The prediction selection screen 400 is a screen for informing the player of receiving a vote, and for causing the player to select a prediction of the result of the vote. On the prediction selection screen 400, messages of receiving the vote and prompting the player to select the prediction of the result of the vote are displayed on a display section 410.

Furthermore, on the prediction selection screen 400, a button 402 and a button 404 are provided. The button 402 is a button to agree to the prediction of the result of the vote. Furthermore, the button 404 is a button not to agree to the prediction of the result of the vote.

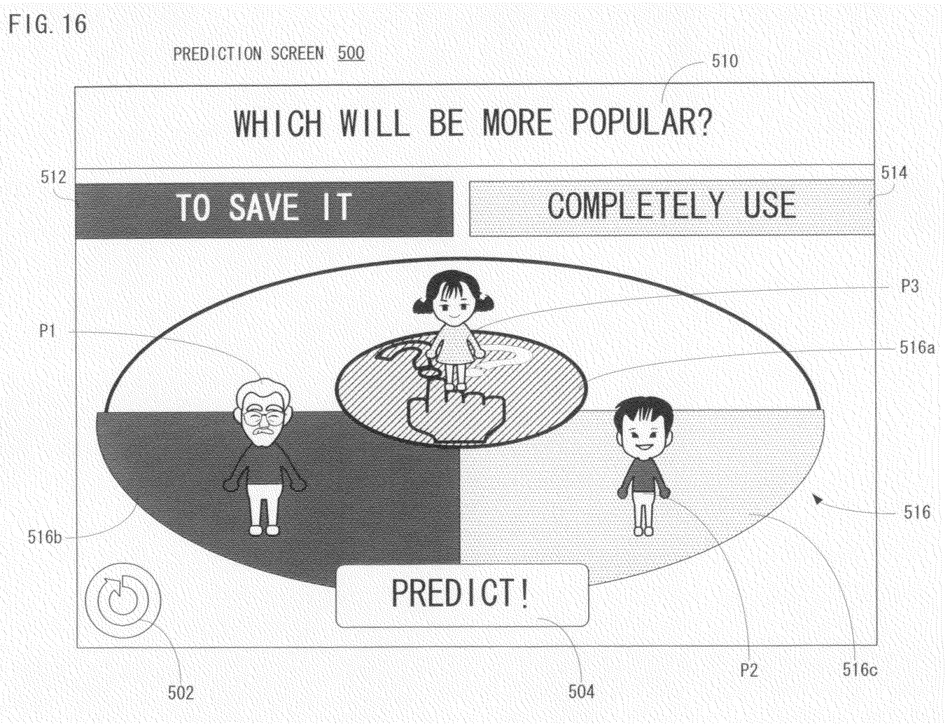

When the button 402 is turned on, that is, in a case that the result of the vote is predicted, a prediction screen 500 as shown in FIG. 16 is displayed on the monitor 34. In a case that the button 404 is turned on, the screen is retuned to the initial screen 100. As shown in FIG. 16, the prediction screen 500 is provided with a display area 510 for displaying a content of the questionnaire relating to the prediction, a display area 512 for displaying a content of a first prediction, and a display area 514 for displaying a content of a second prediction. For convenience of the explanation, the areas 512 and 514 are called the first prediction display area 512 and the second prediction display area 514, respectively. In FIG. 16 example, a question indicating “which is more popular” is displayed on the display area 510, the content of the prediction indicating “saving it” is displayed in the first prediction display area 512, and the content of the prediction indicating “spending completely” is displayed on the second prediction display area 514.

Furthermore, the prediction screen 500 is provided with a selection area 516 for selecting a content of the prediction. The selection area 516 includes an area 516a where a selection has not yet been made (not-yet-predicted area), an area 516b for selecting a first prediction (first prediction selection area), and an area 516c for selecting a second prediction (second prediction selection area).

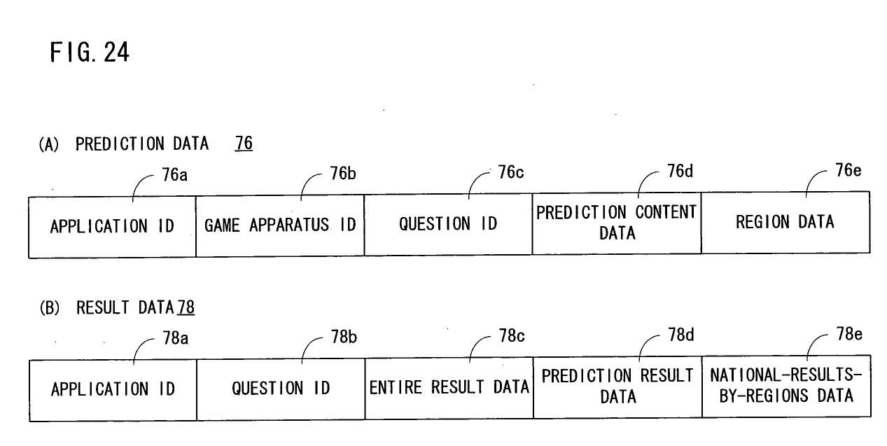

In addition, the prediction screen 500 is provided with a button 502 and a button 504. The button 502 is a button for returning to the initial screen 100. The button 504 is a button for voting a prediction. More specifically, when the button 504 is turned on, prediction data (see FIG. 24 (A)) is transmitted to the delivery server 104.

When the player object is dragged to be moved to the first prediction selection area 516b or the second prediction selection area 516c, and the button 504 is turned on the prediction screen 500, a prediction can be made. Although not represented in the drawing, on the answer screen 300 shown in FIG. 14, for example, the background of the first answer display area 312 and the first answer selection area 316b are applied with the same color (referred to be “first color” for convenience of explanation), and the background of the second answer display area 314 and the second answer selection area 316c are applied with the same color (referred to as “second color” for convenience of explanation). Similarly, on the prediction screen 500 shown in FIG. 16, the background of the first prediction display area 512 and the first prediction selection area 516b are applied with a first color, and the background of the second prediction display area 514 and the second prediction selection area 516c are applied with a second color.

As understood from the prediction screen 500 in FIG. 16, when the questionnaire is answered on the answer screen 300, the color of the clothing (coat) of the player object which has made an answer to the questionnaire is displayed in the color the same as that of the answer selection area. This can show that the player objects P1 and P2 have selected the first answer on the answer screen 300, and the player object P3 has selected the second answer on the answer screen 300.

Although illustration is omitted, when the button 504 is turned on to end the prediction of the result of the vote on the prediction screen 500, that is, when prediction data 76 is transmitted to the delivery server 104, the screen is returned to the initial screen 100.

Returning to FIG. 12, when the button 114 is turned on, an entire result screen 600 relating to the result of the vote (counting result) about the answered questionnaire is displayed on the monitor 34. Although a detailed description is omitted, the questionnaire result data (see FIG. 24 (B)) is included in the above-described download data, and when the player turns the button 114 on, download data acquiring processing is executed to acquire the questionnaire result data from the download data. However, in a case that no answer is made to the questionnaire, even if the questionnaire result data is included in the download data, the questionnaire result data is not acquired. That is, unnecessary data is not acquired.

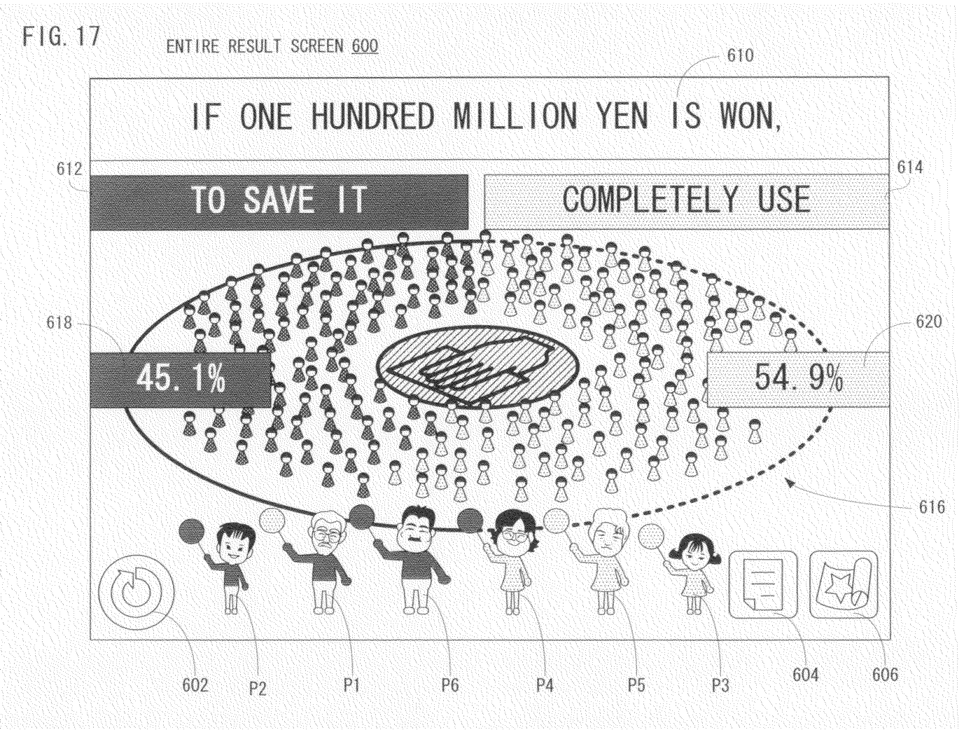

As shown in FIG. 17, the entire result screen 600 is provided with a display area 610 for displaying a content of the questionnaire, an area 612 for displaying the content of the first answer as to the questionnaire (first answer display area), and an area 614 for displaying the content of the second answer (second answer display area). The contents described in the respective display areas (610, 612, and 614) are the same as those described in corresponding display areas (310, 312, and 314) on the answer screen 300, and therefore, a detailed description will be omitted.

Furthermore, on the entire result screen 600, a display area 616 for displaying an entire result is provided, and an area 618 for displaying a ratio of the first answer (first ratio display area), and an area 620 for displaying a ratio of the second answer (second ratio display area) are provided. In the display area 616, a plurality of avatars (non player object) created in advance are set and displayed such that their clothing are colored at a ratio of the result of the questionnaire. In this embodiment, in a case that the total number of the persons who answer the questionnaire is 100%, the ratio of the number of persons who select the first answer to the total numbers is displayed in the first ratio display area 618, and the ratio of the number of persons who select the second answer to the total number is displayed in the second ratio display area 620.

It should be noted that in this embodiment, the total result with respect to the questionnaire is displayed as a percentage, but may be displayed by the number.

Furthermore, on the entire result screen 600, the player objects P1-P6 used in the questionnaire application are displayed at the lower part of the display area 616. As described above, as to each of the player objects P1-P6, the color of the clothing indicates a result of the vote of its own, and the color of the card held with the hand indicates a result of the prediction of its own.

In addition, on the entire result screen 600, a button 602, a button 604, and a button 606 are provided. The button 602a is a button for returning to the initial screen 100. The button 604 is a button for displaying a detailed result. Although illustration is omitted, a result with the sexes separated, a result of the prediction accuracy, for example, can be viewed. The button 606 is a button for displaying a result by region.

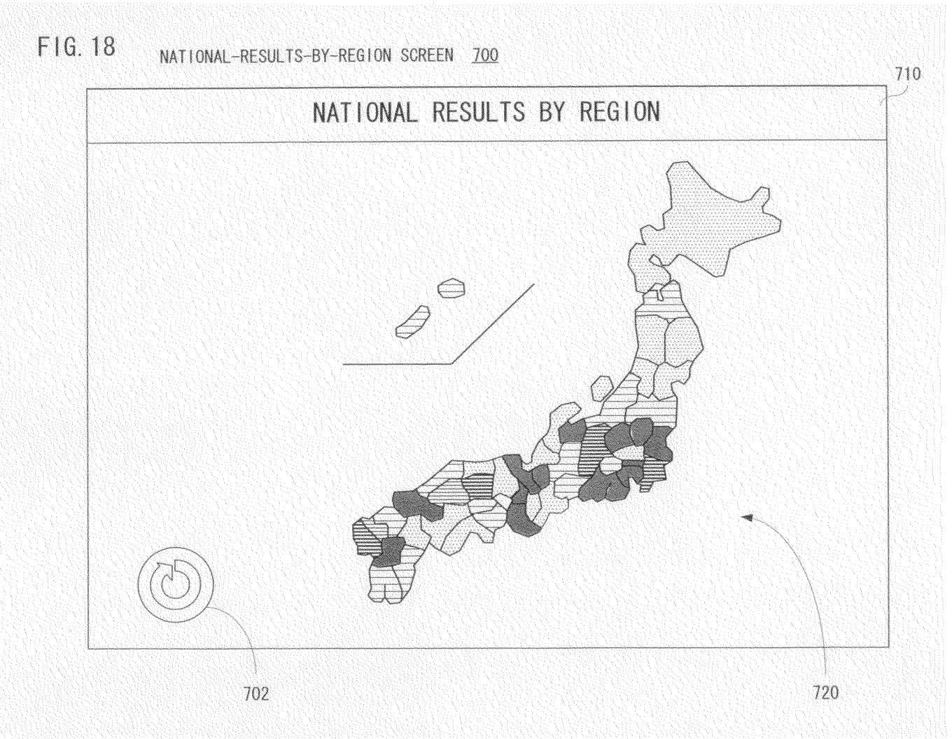

For example, when the button 606 is turned on, a national-results-by-region screen 700 as shown in FIG. 18 is displayed on the monitor 34. The national-results-by-region screen 700 displays a counting result by prefecture. In this embodiment, an example of a result screen by prefecture is shown, but a result by municipalities in a certain prefecture, a result by country, a result by region in another country may be displayed.

As shown in FIG. 18, on the national-results-by-region screen 700, a display area 710 for displaying a result by region, and a map of Japan 720 are displayed. In FIG. 18, in order to make it possible to identify the depth of each of the first color and the second color, in the map of Japan 720, the first color is displayed by striped patterns, and the second color is displayed by spot patterns. Each of the depth of the first color and the second color indicates the degree of bias of the counting result, and as the color is deep, the bias of the counting result is large. However, in FIG. 18, the depth of the color is represented by density of the lines and dots.

In addition, the national-results-by-region screen 700 is provided with a button 702. The button 702 is a button for returning to the initial screen 100.

Returning to FIG. 12, when the button 104 is turned on, an initial screen (not illustrated) of the player data is displayed on the monitor 34. Briefly speaking, the initial screen of the player data is a screen for displaying the player objects (P1-P6) to be used in the questionnaire application in a selectable manner. However, in this embodiment, in the questionnaire application, a maximum of six player objects can be used, but in the initial screen of the player data, only the player objects registered by means of the object selection screen 200 shown in FIG. 13 are displayed.

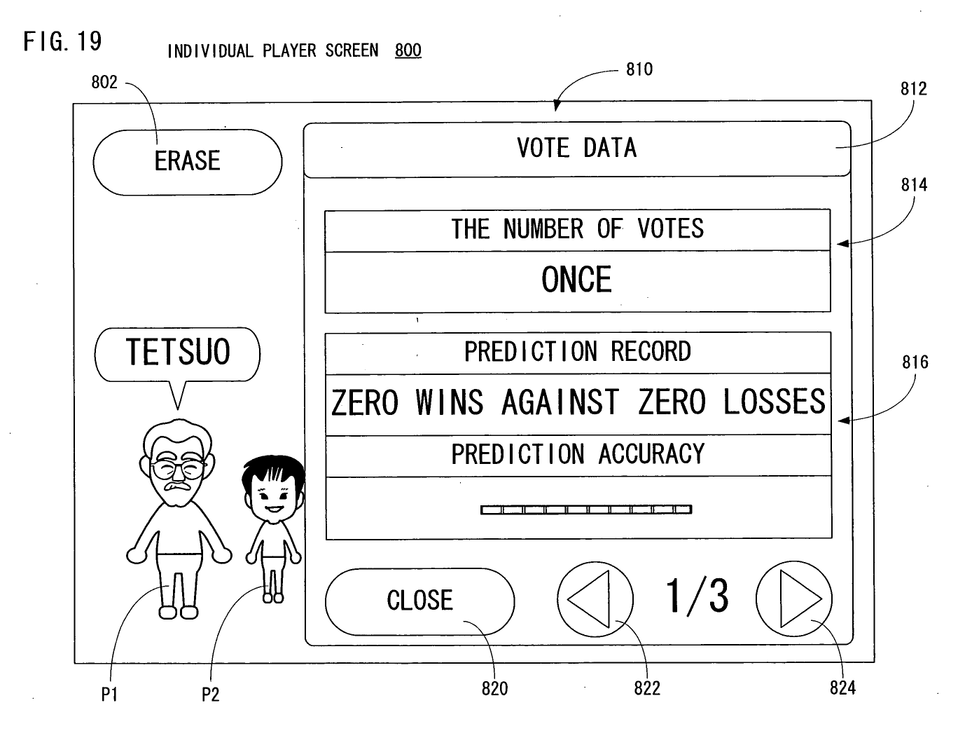

When any one of the player objects (P1-P6) is selected (designated) on the initial screen of the player data, an individual player screen 800 as shown in FIG. 19 is displayed on the monitor 34. The individual player screen 800 is a screen for displaying various information (vote data, a tuned-in degree, a distance from a popular opinion in this embodiment) as to a relevant player object.

The individual player screen 800 is further provided with an information display screen 810. The information display screen 810 is displayed in a manner superposed on the individual player screen 800. It should be noted that within the individual player screen 800, a display area of the information display screen 810 may be provided. The information display screen 810 is provided with a display area 812 for displaying a content of the information (“vote data” in FIG. 19). On the information display screen 810, a display area 814 for displaying the number of votes with respect to a questionnaire and a display area 816 for displaying a prediction record and a prediction accuracy of the result of the vote are provided. As understood from FIG. 19, in the display area 816, the victory or defeat of the record of the prediction is displayed, and the prediction accuracy is displayed by a bar graph. However, this is merely one example, and the prediction accuracy may be displayed such that the percentage is represented by a numerical value.

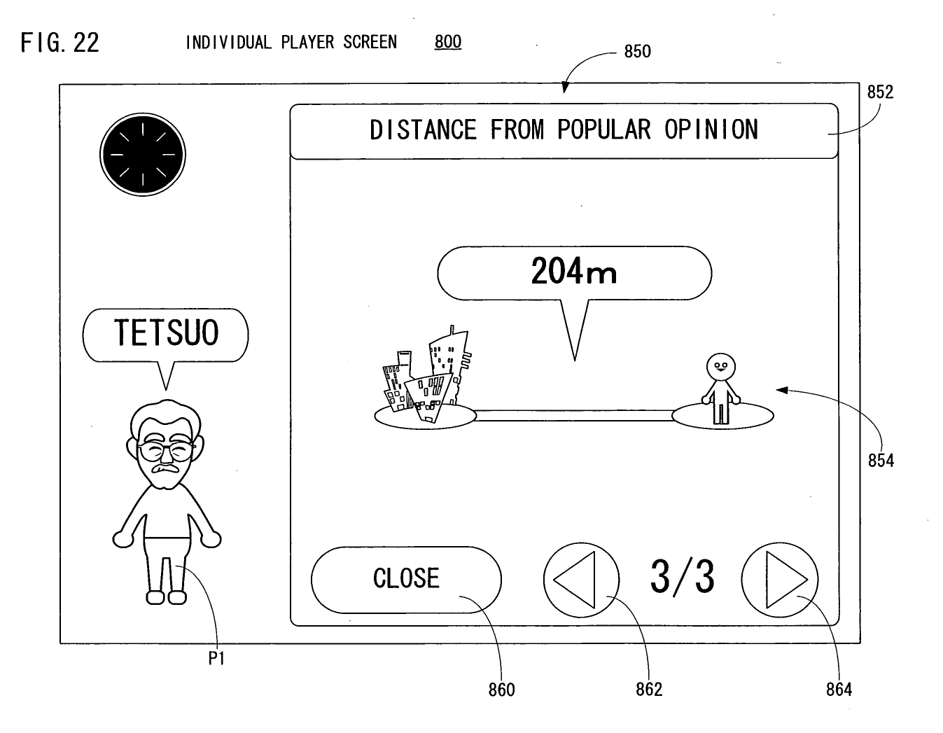

Additionally, on the information display screen 810, a button 820, a button 822 and a button 824 are displayed. The button 820 is a button for closing the information display screen 810, and returning to the initial screen of the player data. The button 822 is a button for returning a page. However, as shown in FIG. 19, when the button 822 is turned on in a state that the information display screen 810 on the 1/3 page is displayed, the information display screen 850 on the 3/3 page (see FIG. 22) is displayed. The button 824 is a button for feeding a page.

On the individual player screen 800, a button 802 is provided. When the button 802 is turned on, player data of the player object which is currently being selected (designated) (see FIG. 23 (A)) can be erased. That is, information such as the number of votes as to the questionnaire, the record of the prediction, etc. is totally erased.

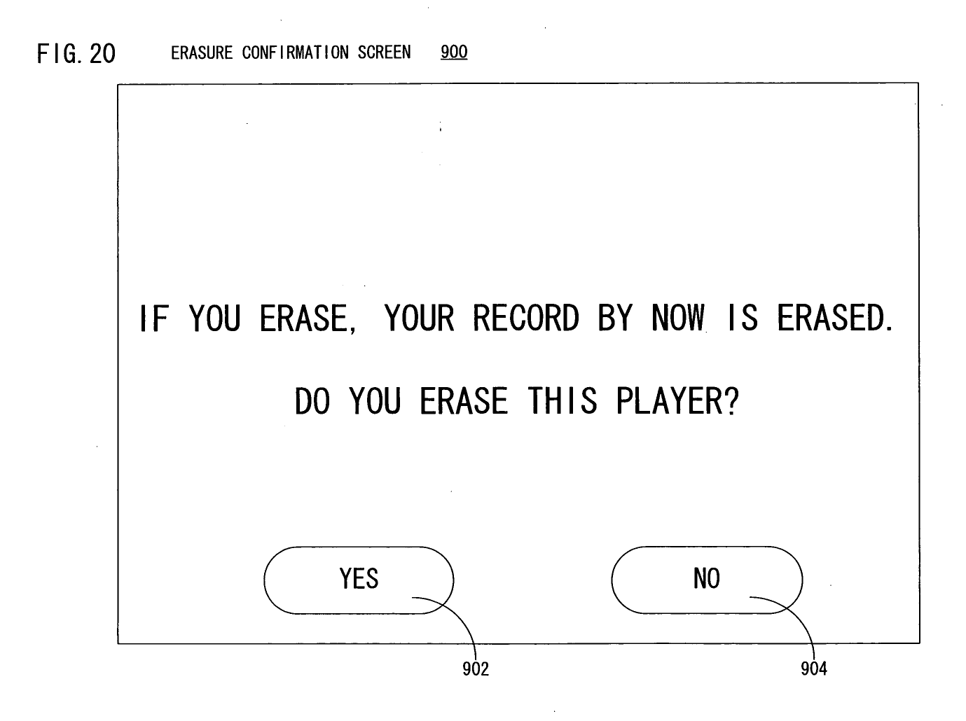

It should be noted that when the button 802 is turned on, an erasure confirmation screen 900 shown in FIG. 20 is displayed. On the erasure confirmation screen 900, a message of erasing the player data and a message of prompting a final confirmation for erasure are displayed. Furthermore, on the erasure confirmation screen 900, a button 902 and a button 904 are displayed. The button 902 is a button for agreeing (allowing) to erasure. The button 904 is a button for stopping erasure.

Although a detailed description is omitted, in a case that there is a questionnaire currently being answered with respect to a player object (player data 70 described later) to be erased (deleted), the player data of the player object cannot be erased. Accordingly, in such a case, before display of the erasure confirmation screen 900, a message showing that erasure is impossible due to the presence of a questionnaire currently being answered is displayed on the monitor 34. If so, it is possible to prevent fraud like answering to the same questionnaire again and again by repeatedly creating and deleting the player data 70 without the delivery server 104 checking the number of answers to one questionnaire from one game apparatus 12.

Although illustration is omitted, when the erasure screen for erasing the player object is displayable, if there is a questionnaire currently being answered with respect to the player object (player data 70 described later) to be erased (deleted), the player object may be no-displayed or grayed out on the erasure screen. That is, if there is a questionnaire currently being answered with respect to the player object, it is impossible to even select the player object for erasure. This makes it possible to prevent the fraud from occurring.

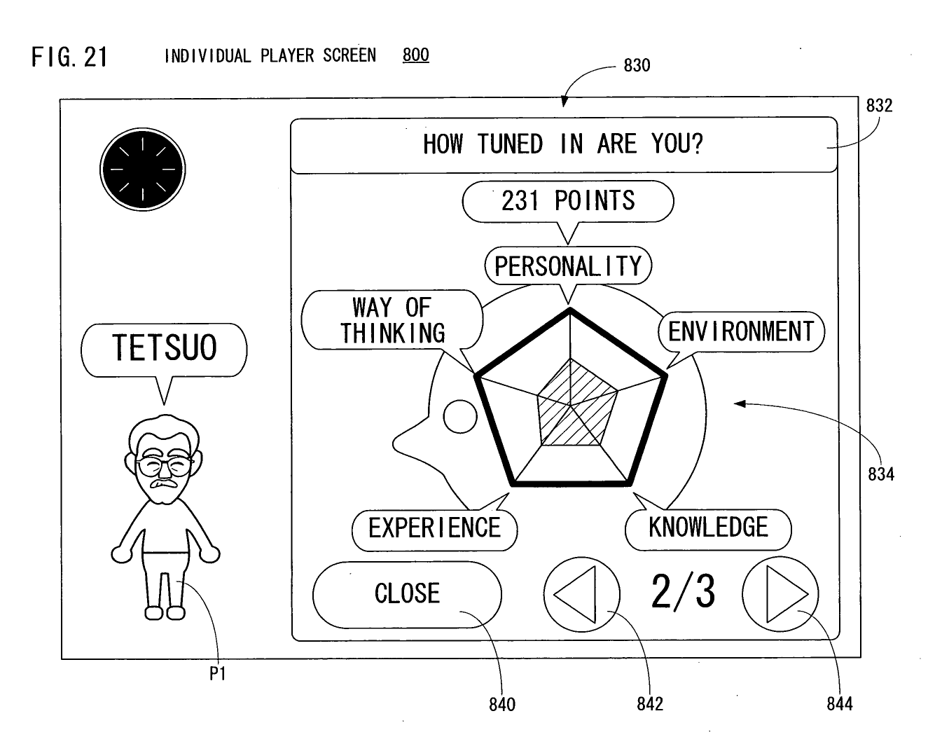

Also, when the button 824 displayed on the information display screen 810 is turned on the individual player screen 800 shown in FIG. 19, the individual player screen 800 is updated as shown in FIG. 21. More specifically, an information display screen 830 is displayed in place of the information display screen 810. The information display screen 830 is provided with a display area 832 for displaying the content of the information (the tuned-in degree in FIG. 21). On the information display screen 830, the information (the tuned-in degree) is visualized by a graph for each of the plurality of categories. In this embodiment, the tuned-in degree is represented by five categories of “personality”, “environment”, “knowledge”, “experience” and “way of thinking”. Additionally, each questionnaire is applied to any one of the categories. Although a detailed description is omitted, a score (point) for each category is calculated, and the total points are displayed by a speech balloon.

Although a detailed description is omitted, in a case that the answer to the questionnaire of the player object is coincident with the answer of the majority in the counting result of the questionnaire, the point of the category corresponding to the questionnaire is added. On the contrary thereto, in a case that the answer to the questionnaire of the player object is coincident with the answer of the minority in the counting result of the questionnaire, the point of the category corresponding to the questionnaire is subtracted.

Furthermore, on the information display screen 830, a button 840, a button 842 and a button 844 are provided. The button 840 is a button for closing the information display screen 830 to return to the initial screen of the player data. The button 842 is a button for returning a page. The button 844 is a button for feeding a page.

When the button 844 on the information display screen 830 is turned on the individual player screen 800 shown in FIG. 21, the screen is updated to an individual player screen 800 as shown in FIG. 22. More specifically, an information display screen 850 is displayed in place of the information display screen 830. On the information display screen 850, a display area 852 for displaying the content of the information (distance from the popular opinion in FIG. 22) is provided. Additionally, on the information display screen 850, an image visualizing a distance from the popular opinion 854 is displayed. For example, the distance (or gap) from the popular opinion is converted into a distance on the basis of the answer to the questionnaire of the player object and the counting result of the questionnaire. Although a detailed description is omitted, as the number (the degree) of coincidences between the answer to the questionnaire by the player object and the answer of the minority in the counting result is large, the gap (distance) from the popular opinion is made large.

Also, on the information display screen 850, a button 860, a button 862 and a button 864 are displayed. The button 860 is a button for closing the information display screen 850 to return to the initial screen of the player data. The button 862 is a button for returning a page. The button 864 is a button for feeding a page.

Next, a description is made on player data 70 managed in the game apparatus 12 and data (question data 72, answer data 74, prediction data 76, and result data 78) transmitted and received between the game apparatus 12 and the delivery server 104.

FIG. 23 (A) shows player data 70. The player data 70 includes identification information (player object ID) 70a of a player object as header information. Furthermore, the player data 70 includes a question ID memory area 70b, history data 70c, prediction data 70d, tuned-in degree data 70e, and gap data 70f. Although illustration is omitted, the player data is stored (saved) in an area assigned to the questionnaire application within the flash memory 44 of the game apparatus 12.

The player object ID70a is identification information for identifying player data (player object). The question ID memory area 70b is an area for storing identification information (question ID) as to the questionnaire (question) about which the player object makes an answer, and includes a plurality of memory areas (four in this embodiment) (first memory area 70b1, second memory area 70b2, third memory area 70b3, fourth memory area 70b4). In this embodiment, every time that the player object makes an answer to the questionnaire, a question ID of a questionnaire is stored from the first memory area 70b1, the second memory area 70b2, the third memory area 70b3, and the fourth memory area 70b4 in this order. When the player object answers a questionnaire in a state that the question IDs are stored in the first memory area 70b1 to the fourth memory area 70b4, the first memory area 70b1 is overwritten with the question ID stored in the second memory area 70b2, the second memory area 70b2 is overwritten with the question ID stored in the third memory area 70b3, the third memory area 70b3 is overwritten with the question ID stored in the fourth memory area 70b4, and then, the fourth memory area 70b4 is overwritten with the question ID of the questionnaire about which the answer is made.

In this embodiment, the reason why only the four memory areas for the question ID of the player data 70 are provided is that it is sufficient for storing question IDs for three questionnaires for display and for one preliminary questionnaire. In a case that four or more questionnaires are made displayable on the initial screen 100, the player data 70 is only necessary to be provided with the memory area by the number obtained by adding the number of preliminary questionnaires (one in this embodiment) to the number of displayed questionnaires. Furthermore, in a case that three questionnaires are not necessarily displayed on the initial screen 100, there is no need of storing a preliminary questionnaire in the main memory (42e, 46) in advance, and in such a case, the number of the memory areas to be provided to the player data 70 is provided by the number of questionnaires for display.

The history data 70c is data of a history as to the question ID of the answered questionnaire and the content of the answer and the number of the answered questionnaires. However, the histories of the question ID and the content of the answer are stored by a predetermined number (12, for example) to thereby prevent the capacity of the memory from being consumed. The prediction data 70d is data of a history of prediction, the win or lost of the prediction, and prediction accuracy of the player object. The tuned-in data 70e is data of points for each category and the total points of the tuned-in degree of a player object. The gap data 70f is data of a numerical value obtained by representing a gap with the popular opinion by a distance.

FIG. 23 (B) shows question data 72. The question data 72 (download data) is delivered from the delivery server 104 to the game apparatus 12 while the questionnaire application takes it from the download box 440 to a folder assigned to its own of the save area 44f. The question data 72 includes an application ID 72a as header information, and furthermore includes a question ID 72b, question content data 72c and answer dead line data 72d.

The application ID 72a is identification information for identifying the kind of an application, and describing identification information assigned to the questionnaire application in this embodiment. In what follows, the same is true for the embodiment, and therefore, a duplicated description will be omitted. The question ID 72b is identification information as to questionnaire, that is, questionnaire data (question content data). In what follows, the same is true for the embodiment, and therefore, a duplicated description will be omitted. The question content data 72c is text data as to a content of the question (questionnaire). The answer dead line data 72d is data indicative of a dead line of an answer to a question (end date and time) or a term for answer to a question (start date and time and end date and time).

FIG. 23 (C) shows answer data 74. The answer data 74 is answer data to a questionnaire (question) generated when the button 304 is turned on the answer screen 300 shown in FIG. 14 and transmitted from the game apparatus 12 to the delivery server 104. The delivery server 104 receives (collects questionnaires) answer data 74 transmitted from a plurality of game apparatuses 12 connected to the network 106, and counts the questionnaires according to the received answer data 74. Then, it delivers a counting result (described later result data 78) to all the game apparatuses 12 connected to the network 106.

The answer data 74 includes an application ID 74a as header information, and further includes a game apparatus ID 74b, a question ID 74c, answer content data 74d and region data 74e. The game apparatus ID 74b is identification information specific to the game apparatus 12. The reason why the game apparatus ID 74b is included in the answer data 74 is that the answer of the questionnaire is accepted by the number of the player objects (P1-P6). Accordingly, when the answer applied with the same game apparatus ID as to one questionnaire reaches a maximum number of player objects (six in this embodiment), the delivery server 104 does not accept the answer data 74 including the game apparatus ID and the question ID from then on.

The answer content data 74d is data indicative of a detailed content of an answer to the questionnaire indicated by the question ID 74c. More specifically, the answer content data 74d is numerical value data as to the number of males with the first answer, the number of females with the first answer, the number of males with the second answer, and the number of females with the second answer. It should be noted that these numerical value data is detected when the button 304 is turned on the answer screen 300. More specifically, the number of males with the first answer is the number of male player objects existing in the first answer selection area 316b, and the number of females with the first answer is the number of female player objects existing in the first answer selection area 316b. Furthermore, the number of males with the second answer is the number of male player objects existing in the second answer selection area 316c, and the number of females with the second answer is the number of female player objects existing in the second answer selection area 316c. However, the number of player objects grayed out once after voting the answer is not included. The region data 74e is data as to a region (prefectures in this embodiment) included in an option set on the initial screen 100 by the player.

FIG. 24 (A) shows prediction data 76. The prediction data 76 is prediction data of the counting result relating to the questionnaire generated when the player turns the button 504 on the prediction screen 500 shown in FIG. 16, and transmitted from the game apparatus 12 to the delivery server 104. The delivery server 104 receives (collects the prediction) the prediction data 76 transmitted from a plurality of game apparatuses 12 connected to the network 106, and counts the prediction as to the questionnaire according to the received prediction data 76. Then, the counting result (result data 78 described later) is delivered to all the game apparatuses 12 connected to the network 106.

The prediction data 76 includes an application ID 76a as a header, and further includes a game apparatus ID 76b, a question ID 76c, prediction content data 76d and region data 76e. The content except for the content of the prediction content data 76d is the same as the above-described answer data 74 and therefore, a duplicated description is omitted.

The prediction content data 76d is data of a content of a prediction as to the questionnaire indicated by the question ID 76c. More specifically, the prediction content data 76d is numerical value data each indicating the number of males predicting the first answer, the number of females predicting the first answer, the number of males predicting the second answer, and the number of females predicting the second answer.

FIG. 24 (B) shows result data 78. The result data 78 is data as to the counting result of a questionnaire. The result data 78 is delivered from the delivery server 104. That is, the result data 78 is downloaded from the delivery server 104 by the input-output processor 42a.

The result data 78 includes an application ID 78a as header information, and further includes a question ID 78b, entire result data 78c, prediction result data 78d and national-results-by-region data 78e. The entire result data 78c is numerical value data of the number of first answers (the number of males and females with the first answer) and the number of second answers (the number of males and females with the second answer) with respect to the questionnaire indicated by the question ID 78b out of the total number of votes. However, the numerical value data may be a result of the calculation of the ratio for each of the first answer and the second answer.

The prediction result data 78d is numerical value data of the number of predictions of the first answer (the number of males and females predicting the first answer) and the number of predictions of the second answer (the number of males and females predicting the second answer) as to a questionnaire indicated by the question ID 78b out of the total number of predictions. However, the numerical value data may be a result of the calculation of the ratio for each of the prediction of the first answer and the prediction of the second answer.

The result-data-by-region data 78e is data as to blank map data (data of map of Japan in this embodiment) and a content of the answer for each region (the number of males with the first answer, the number of females with the first answer, the number of males with the second answer, and the number of females with the second answer).

The reason why the result-data-by-region data 78e is included in the map data is for making flexibly adaptable to the change of the unit in the region and the change of a displaying method of the result for each region.

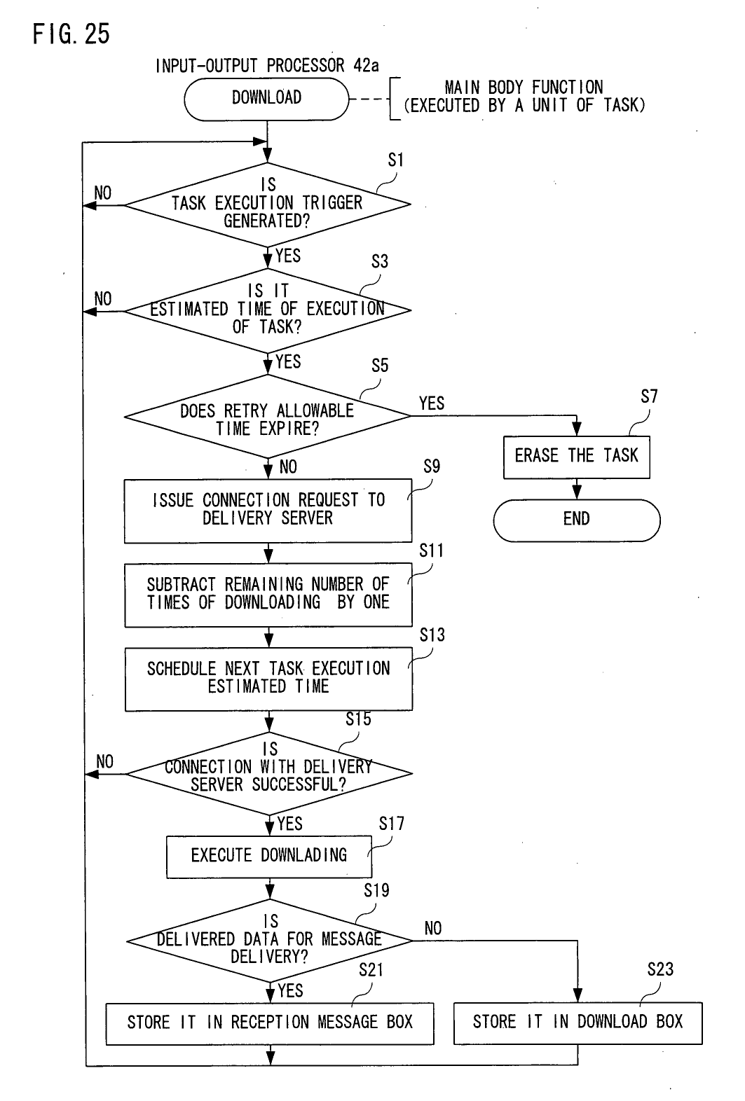

In what follows, a description is made on detailed processing by using flowcharts. FIG. 25 is a flowchart showing download processing of the input-output processor 42a shown in FIG. 2. The download processing is executed by the input-output processor 42a independent of the CPU 40, and is executed in the above-described standby mode. Furthermore, while the CPU 40 executes an application (without being limited to the questionnaire application), it is independently executed. It should be noted that the download processing continues to be executed every time that a trigger is generated within the input-output processor 42a as described above in a state a task is registered. Furthermore, the download processing is executed in each task.

As shown in FIG. 25, the input-output processor 42a detects generation of a trigger (task execution trigger) for executing a task in a step S1. If “NO” in the step S1, that is, if a task execution trigger is not generated, the process returns to the step S1 as it is. On the other hand, if “YES” in the step S1, that is, if a task execution trigger is generated, it is determined whether or not an estimated time of execution of the task has come in a step S3. Strictly speaking, the input-output processor 42a determines whether or not the current hour is after the execution estimated time.

If “NO” in the step S3, that is, if it is not the estimated time of execution of the task, the process returns to the step S1 as it is. On the other hand, if “YES” in the step S3, that is, if it is the estimated time of execution of the task, it is determined whether or not a retry allowable time expires in a step S5. If “YES” in the step S5, that is, if the retry allowable time expires, the task is erased from the task list 44e in a step S7, and the download processing is ended.

However, since the download processing is executed for each task, this means that the task relating to the download processing is ended, but the download processing as to other task is activated in response to the generation of the trigger.

On the other hand, if “NO” in the step S5, that is, if it is not after a retry allowable time, a connection request is transmitted to the delivery server 104 in a step S9. That is, the input-output processor 42a sends an access request to the URL of the acquiring source of the content, that is, download data (questionnaire data or result data in this embodiment) indicated by the attribute of the task. Succeedingly, in a step S11, the remaining number of times of downloading as to the task is subtracted by one. Here, although illustration is omitted, the input-output processor 42a deletes the task from the task list 44e at a time when the remaining number of times of downloading becomes zero so as to prevent a next downloading from being performed. In a step S13, a next task execution estimated time is scheduled.

Then, in a step S15, it is determined whether or not a connection with the delivery server 104 is successful. If “NO” in the step S15, that is, if a connection with the delivery server 104 is unsuccessful, the process directly returns to the step S1. In this embodiment, the input-output processor 42a directly returns to the step S1 when a connection with the delivery server 104 is unsuccessful, but where a connection is unsuccessful even if a connection request is issued at predetermined number of times (three times of retry, for example), the process may be returned to the step S1. Furthermore, in a case that an error occurs to the network 106 and the server (104), the retry may not be performed. Furthermore, in such an error, when the above-described subtraction of the remaining number of times is performed, the process may be ended without executing a download, and therefore, the process in the step S11 is performed after the step S15.

If “YES” in the step 15, that is, if a connection with the delivery server 104 is successful, downloading is executed in a step S117. That is, the input-output processor 42a acquires download data. Then, in a step S19, it is determined whether or not the download data is data for a message delivery. For example, if the data for message delivery is the data in an electronic mail format, the input-output processor 42a determines whether or not the acquired download data is in an electronic mail format. Or, information indicative of the message delivery data is included in the download data, and after execution of the download, the download data may be transformed into the data in an electronic mail format in the game apparatus 12. For example, in this embodiment, the content delivered as message delivery data is considered to be a message showing that a new questionnaire and the counting result of an questionnaire is delivered from the source of the delivery (delivery server 104).

If “YES” in the step 19, that is, if the download data is data for message delivery, the download data is stored in the reception message box 44b as reception data in a step S21, and the process returns to the step S1. On the other hand, if “NO” in the step S19, that is, if the download data is not data for message delivery, the download data is stored in the download box 440 in a step S23, and the process then returns to the step S1.

The above-described download processing is basically executed by the input-output processor 42a independent of the CPU 40 during execution of an application like a questionnaire application in this embodiment, a game application by the CPU 40 and during the stand-by mode.

The message delivery data stored in the reception message box 44b is output to the monitor 34 by a message board function, and a message from the source of the delivery is notified to the player.

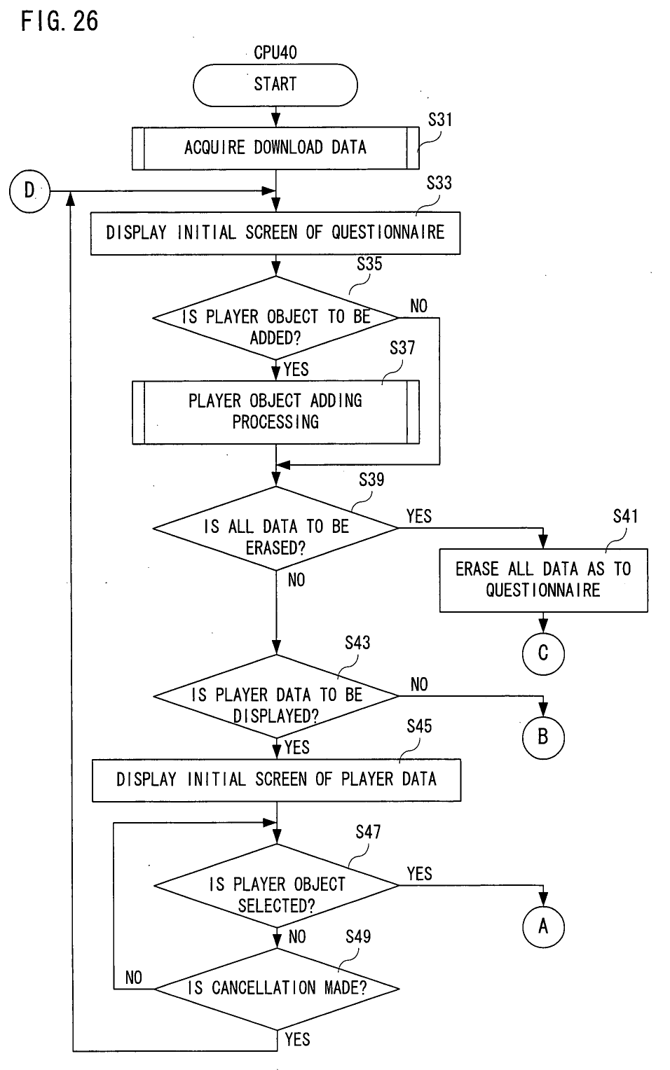

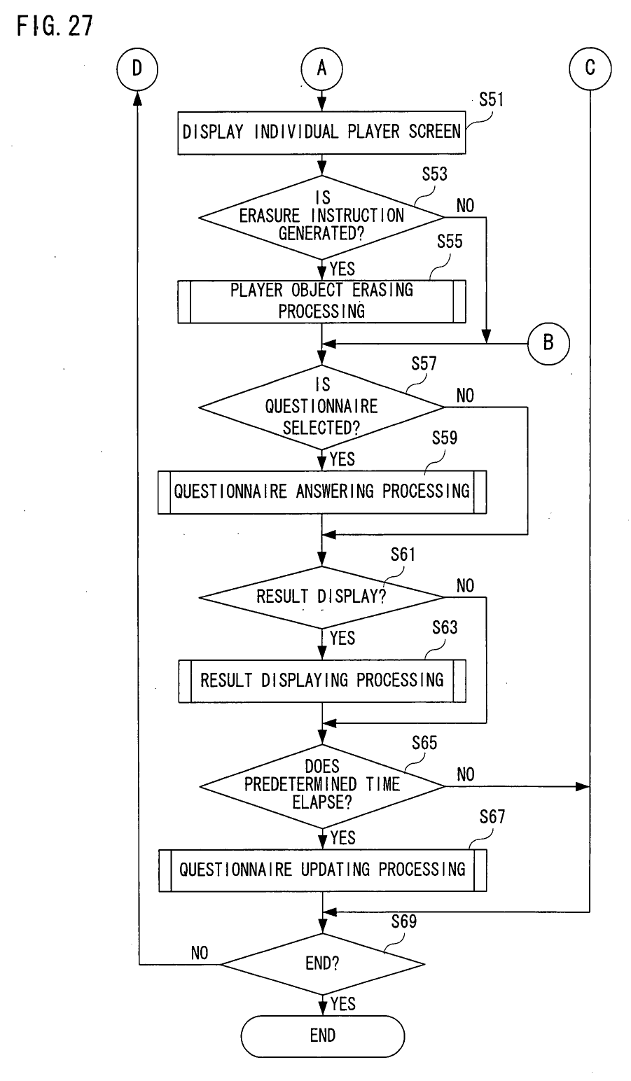

FIG. 26 and FIG. 27 are a flowchart showing an entire process of the questionnaire application. However, for sake of simplicity, illustration is omitted of processing about a part of function which is not an essential content of the present invention such as setting options.

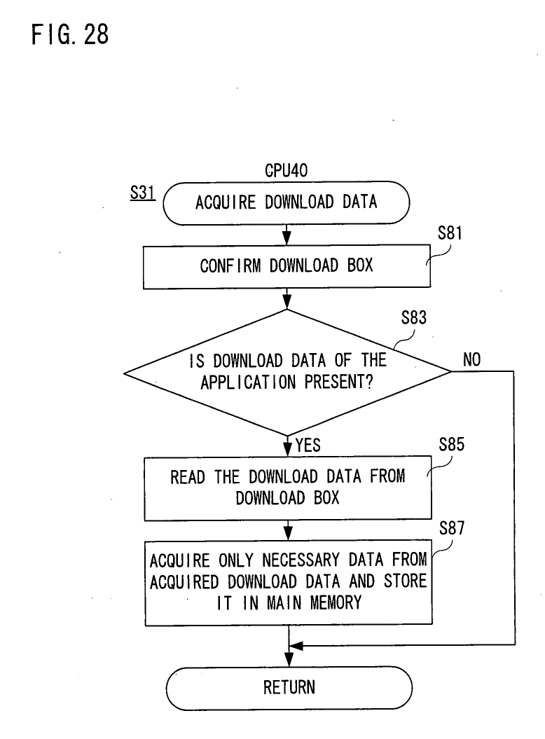

As shown in FIG. 26, when an entire process of the questionnaire application is started, download data acquiring processing (see FIG. 28) described later is executed in a step S31. In a following step S33, an initial screen 100 shown in FIG. 12 is displayed on the monitor 34. Although a detailed description is omitted, with reference to save data, contents and answer dead lines of questionnaires are displayed in the display areas 152, 154, and 156 on the initial screen 100.

In a following step S35, it is determined whether or not a player object is to be added. More specifically, it is determined whether or not a button 102 is turned on (instruction for addition (registration) of the player object) on the initial screen 100.

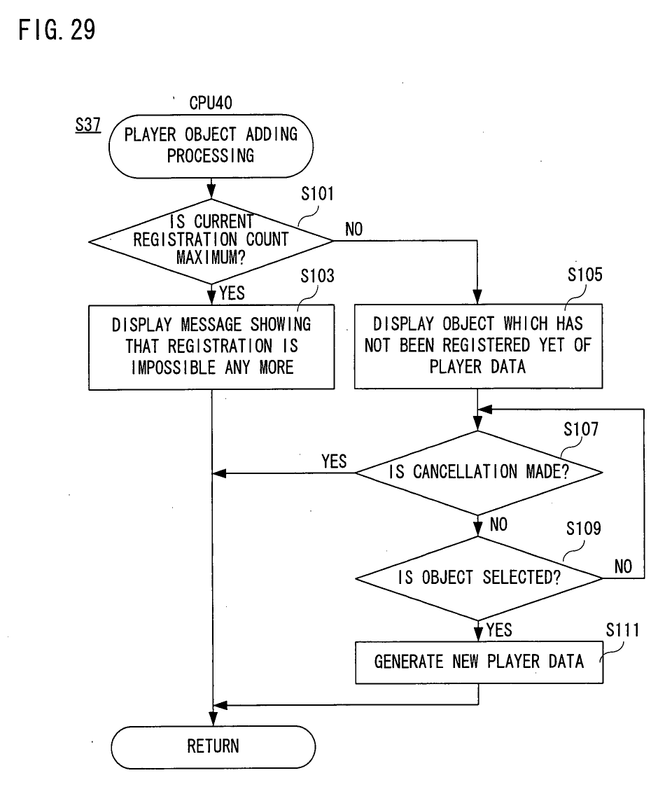

If “NO” in the step S35, that is, if a player object is not to be added, the process proceeds to a step S39 as it is. On the other hand, if “YES” in the step S35, that is, if a player object is to be added, player object adding processing (see FIG. 29) described later is executed in a step S37, and the process proceeds to the step S39.

In a case that the questionnaire application is first started-up, the player object is sure to be registered, and therefore, the player object adding processing (see FIG. 29) described later is executed in the step S37 and then, the process proceeds to a step S39 without performing display of the initial screen 100 by the step S33, and determination about addition of a player object in the step S35.

In the step S39, it is determined whether or not all the data is to be erased. Here, in setting an option on the initial screen 100, it is determined whether or not an instruction for erasing all the data is input. If “YES” in the step S39, that is, if all the data is to be erased, all the data relating to the questionnaires is erased in a step S41. More specifically, all the data (save data) is erased from the data memory areas in the main memories (42e and 46), and then, the process proceeds to a step S69 shown in FIG. 27. On the other hand, if “NO” in the step S39, that is, if all the data is not to be erased, the process directly proceeds to a step S43.

In the step S43, it is determined whether or not player data is to be displayed. Here, it is determined whether or not the button 104 is turned on (displaying the player data is instructed) on the initial screen 100. If “NO” in the step S43, that is, if player data is not to be displayed, the process proceeds to a step S57 shown in FIG. 27 as it is. On the other hand, if “YES” in the step S43, that is, if player data is to be displayed, an initial screen (not illustrated) of the player data is displayed on the monitor 34 in a step S45.

In a succeeding step S47, it is determined whether or not a player object is selected. If “NO” in the step S47, that is, if a player object is not selected, it is determined whether or not a cancellation is made in a step S49. More specifically, it is determined whether or not an instruction for returning to the initial screen 100 is input. If “YES” in the step S49, that is, if a cancellation is made, the process returns to the step S33. On the other hand, if “NO” in the step S49, that is, if a cancellation is not made, the process returns to the step S47 as it is to wait for a selection of the player object.

However, if “YES” in the step S47, that is, if a player object is selected, an individual player screen 800 shown in FIG. 19 is displayed on the monitor 34 in a step S51 shown in FIG. 27, and it is determined whether or not an erasure instruction is generated in a step S53. That is, it is determined whether or not a button 802 is turned on (an erasure instruction is input) on the individual player screen 800.

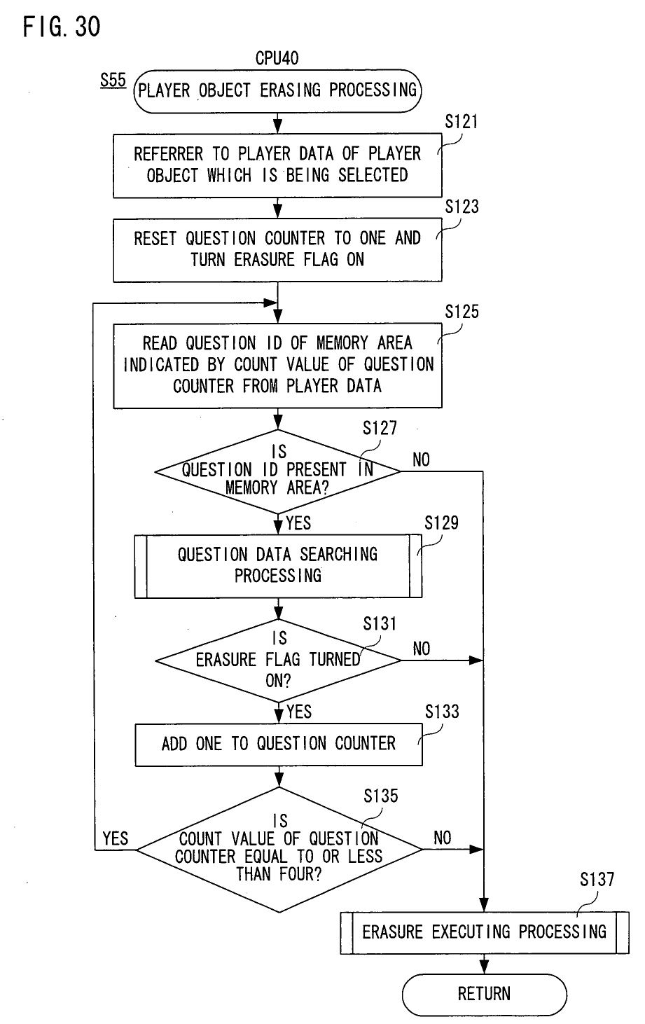

If “NO” in the step S53, that is, if an erasure instruction is not generated, the process proceeds to the step S57 as it is. On the other hand, if “YES” in the step S53, that is, if an erasure instruction is issued, player object erasing processing (see FIG. 30) described later is executed in a step S55, and the process advances to the step S57.

Additionally, in FIG. 27, for simplicity, if “NO” in the step S53, the process proceeds to the step S57 as it is, but as described above, various information (information screens 810, 830, and 850) can be displayed on the individual player screen 800.

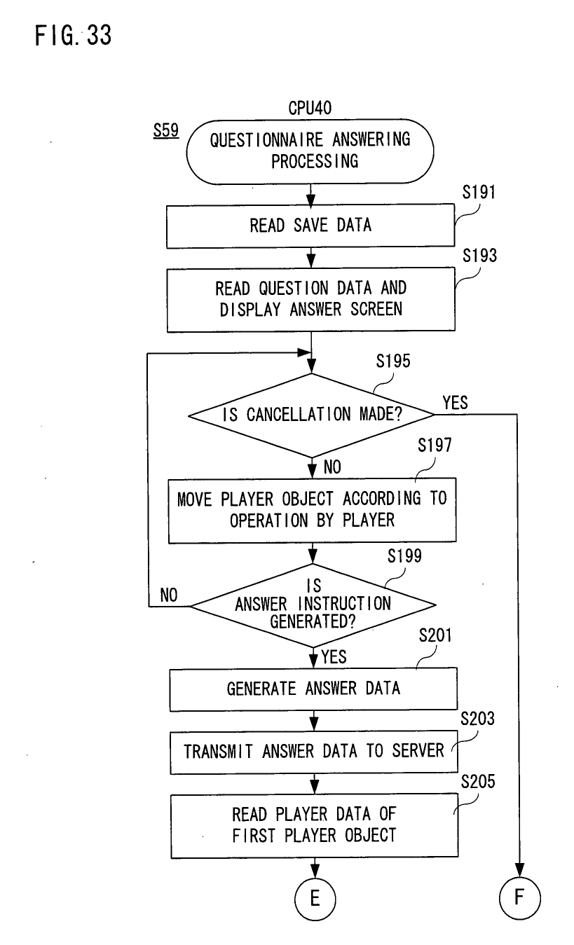

In the step S57, it is determined whether or not a questionnaire is selected. That is, it is determined whether or not any one of the display areas 152, 154, and 156 is selected (instructed) on the initial screen 100. If “NO” in the step S57, that is, if a questionnaire is not selected, the process proceeds to a step S61 as it is. On the other hand, if “YES” in the step S57, that is, if a questionnaire is selected, questionnaire answering processing (see FIG. 33) described later is executed in a step S59, and the process proceeds to the step S61.

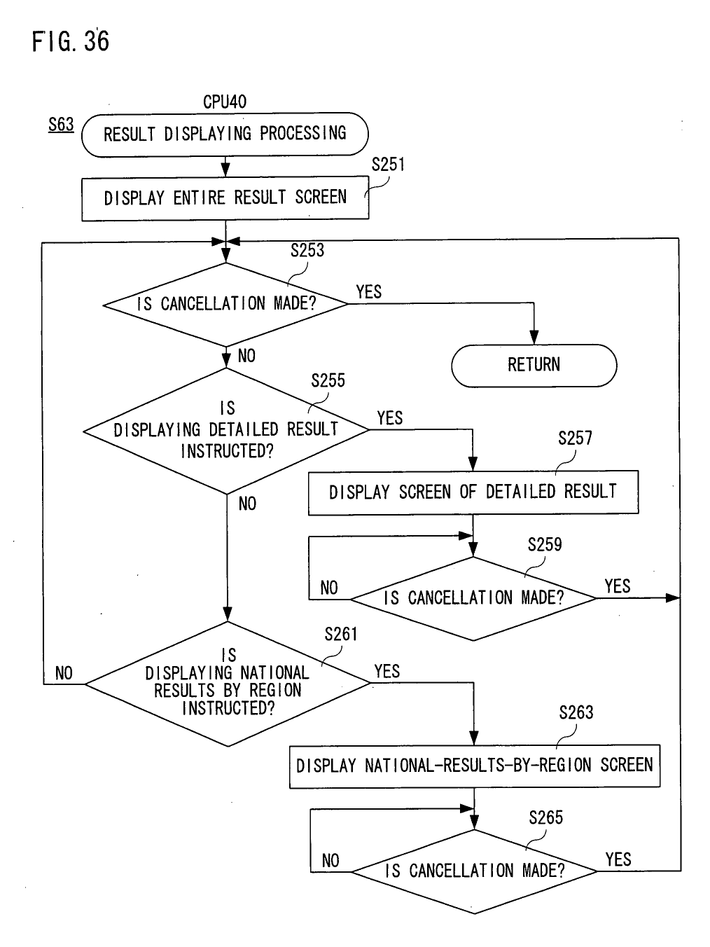

In the step S61, it is determined whether or not a result display is performed. That is, it is determined whether or not the button 114 is turned on the initial screen 100 (result display is instructed). If “NO” in the step S61, that is, if a result display is not performed, the process proceeds to a step S65 as it is. On the other hand, if “YES” in the step S61, that is, if a result display is performed, result displaying processing (see FIG. 36) described later is executed in a step S63, and the process proceeds to the step S65.

In the step S65, it is determined whether or not a predetermined time has elapsed. Although a detailed description is omitted, a timer (not illustrated) is integrated in the game apparatus 12, and counts a time in a state the power of the game apparatus 12 is turned on (including a stand-by state). Whether or not the timer counts a predetermined time (four hours, for example) is determined.

Additionally, if the timer counts a predetermined time, a flag indicating this is turned on, and when questionnaire updating processing (S67) is executed, the flag is turned off as described later. Furthermore, the timer is reset and started after the questionnaire updating processing is executed.

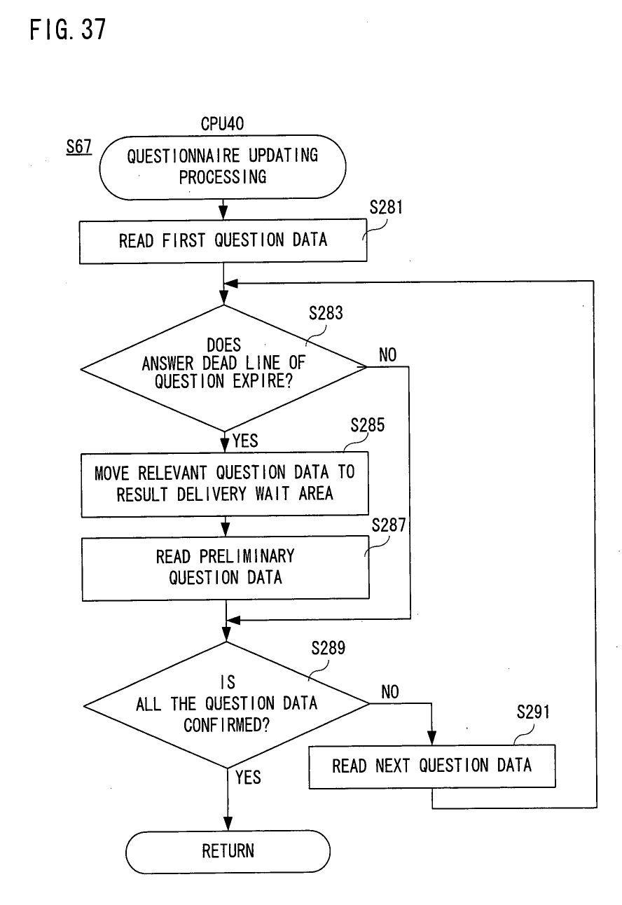

If “NO” in the step S65, that is, if a predetermined time has not elapsed, the process advances to a step S69 as it is. On the other hand, if “YES” in the step S65, that is, if a predetermined time has elapsed, questionnaire updating processing (see FIG. 37) described later is executed in the step S67, and the process proceeds to the step S69.

In the step S69, it is determined whether or not the entire processing of the questionnaire application is to be ended. For example, it is determined whether or not the button 110 is turned on the initial screen 100, that is, whether or not an instruction of returning to the menu program screen at a start of activating the game apparatus 12 is input. If “NO” in the step S69, that is, if the entire processing of the questionnaire application is not to be ended, the process returns to the step S33 shown in FIG. 26. On the other hand, if “YES” in the step S69, that is, if the entire processing of the questionnaire application is to be ended, the process ends the entire processing as it is.

FIG. 28 is a flowchart showing the download data acquiring processing in the step S31 shown in FIG. 26. As shown in FIG. 28, when starting the processing, the CPU 40 confirms the download box 440 in a step S81. Then, in a step S83, it is determined whether or not there is download data of the application. That is, the CPU 40 determines whether or not download data identified with the application ID of the questionnaire application is stored in the download box 440.

If “NO” in the step S83, that is, if download data of the application is not stored, the process returns as it is. On the other hand, if “YES” in the step S83, that is, if download data of the application is stored, the download data is read from the download box 440 in a step S85, and only the necessary data (question data 72 and result data 78) is obtained from the acquired download data and stored in the main memories (42e and 46) in a step S87, and then, the entire processing is returned. Thus, the download data is used in the entire process in the successive questionnaire application.

Additionally, the CPU 40 is accessible at a high speed to both of the internal memory 42e and the external memory 46, and therefore, reception data and download data may be stored in either memory. For example, the reception data and the download data may be stored in a memory the same as the memory utilized in the questionnaire application (program) and its save data.

FIG. 29 is a flowchart showing player object adding processing shown in a step S37 in FIG. 26. As shown in FIG. 29, when starting the player object adding processing, the CPU 40 determines whether or not a current registration count is a maximum (six, for example) in a step S101. That is, it is determined whether or not six player data 72 is included in the save data. If “YES” in the step S101, that is, if the current registration count is a maximum, a message showing that registration is impossible any more is displayed on the monitor 34 in a step S103, and the process is returned to the entire process.

However, if “NO” in the step S101, that is, if a current registration count is not a maximum, an object which has not been registered yet as player data is displayed in a step S105. More specifically, the CPU 40 displays an object selection screen 200 shown in FIG. 13 on the monitor 34. In a succeeding step S107, it is determined whether or not a cancellation is made. That is, it is determined whether or not the button 202 is turned on on the object selection screen 200 (instruction for returning to the initial screen 100).

If “YES” in the step S107, that is, if a cancellation is made, the process returns to the entire process. Although illustration is omitted, an initial screen 100 is displayed on the monitor 34 here. In what follows, in a case that the processing is cancelled in this embodiment, a similar initial screen 100 is displayed on the monitor 34, and therefore, a duplicated description is omitted.

On the other hand, if “NO” in the step S107, that is, if a cancellation is not made, it is determined whether or not an object is selected in a step S109. That is, it is determined whether or not a player selects a desired player object. If “NO” in the step S109, that is, if an object is not selected, the process returns to the step S107 as it is. On the other hand, if “YES” in the step S109, that is, if an object is selected, new player data is generated in a step S111, and the process returns to the entire process. More specifically, in the step S111, the CPU 40 generates player data 70 as to the selected player object, and stores it in the main memory (42e and 46).

For simplicity, although omitted in FIG. 29, as explained by utilizing the object selection screen 200 shown in FIG. 13, the display can be updated by returning or feeding pages in response to the button 204 or the button 206 being turned on or off on the object selection screen 200.

FIG. 30 is a flowchart showing the player object erasing processing in the step S55 shown in FIG. 27. As shown in FIG. 30, starting the erasing processing of the player object, the CPU 40 referrers to player data 70 of a player object which is being selected stored in the main memories (42e and 46) in a step S121. In a succeeding step S123, one is set to a count value of the question counter, and an erasure flag is reset to be turned on.

Although illustration is omitted, the question counter and the erasure flag are provided in the main memories (42e and 46). The question counter is a counter for subsequently searching the memory areas 70b1-70b4 included in the player data 70, and the erasure flag is a flag for identifying whether or not player data (player object) as an erasable object is erasable.

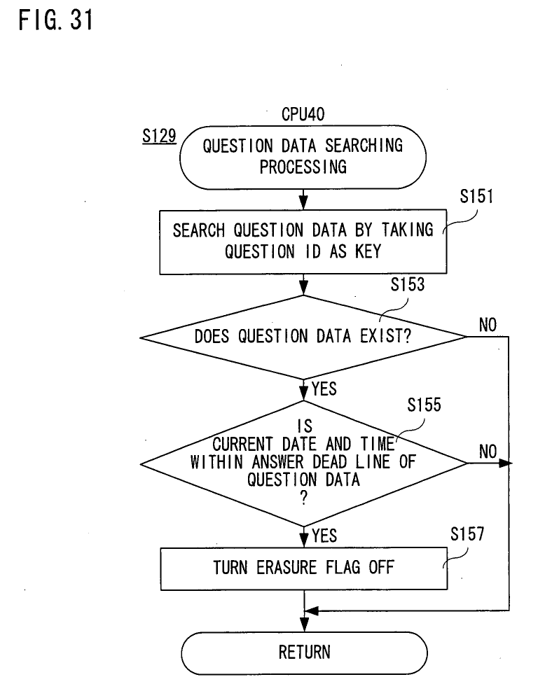

Succeedingly, in a step S125, a memory area (70b1, 70b2, 70b3 or 70b4) indicated by the count value of the question counter is read from the player data 70 as an erasable object. Then, in a step S127, it is determined whether or not a question ID is stored in the memory areas (70b1, 70b2, 70b3 and 70b4). If “NO” in the step S127, that is, if a question ID is not stored in the memory areas (70b1, 70b2, 70b3 and 70b4), the process proceeds to a step S137. On the other hand, if “YES” in the step S127, that is, if a question ID is stored in the memory areas (70b1, 70b2, 70b3 or 70b4), question data searching processing (see FIG. 31) described later is executed in a step S129, and then, the process proceeds to a step S131.

In the step S131, it is determined whether or not the erasure flag is turned on. That is, it is determined whether or not the player data 70 is erasable. If “NO” in the step S131, that is, if the erasure flag is turned off, the process proceeds to the step S137 as it is. On the other hand, if “YES” in the step S131, that is, if the erasure flag is turned on, one is added to the question counter in a step S133. Then, in a step S135, it is determined whether or not the count value of the question counter is equal to or less than four.

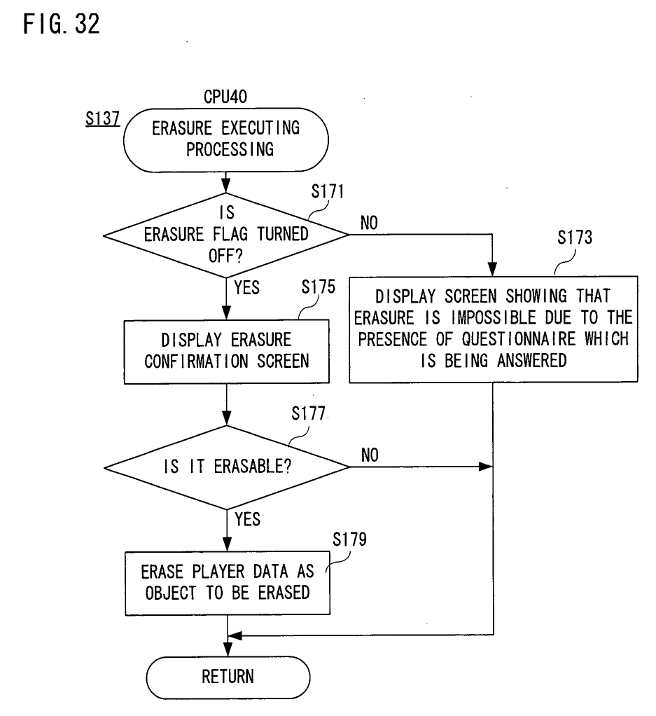

If “YES” in the step S135, that is, if the count value of the question counter is equal to or less than four, it is determined that all the memory areas (70b 1, 70b2, 70b3 and 70b4) of the player data 70 are not searched, and then, the process returns to the step S125. On the other hand, if “NO” in the step S135, that is, if the count value of the question counter is equal to or more than five, it is determined that all the memory areas (70b1, 70b2, 70b3 and 70b4) of the player data 70 have been searched, and the process proceeds to the step S137. In the step S137, erasure executing processing (FIG. 32) described later is executed, and the process is returned to the entire process.

FIG. 31 is a flowchart showing question data searching processing in the step S129 shown in FIG. 30. As shown in FIG. 31, when starting the question data searching processing, the CPU 40 searches question data 72 taking the question ID stored in the memory areas (70b 1, 70b2, 70b3 and 70b4) as a key in a step S151. In a succeeding step S153, it is determined whether or not question data 72 having the question ID exists in the main memory (42e and 46). If “NO” in the step S153, that is, if the question data 72 does not exist, the process is returned to the player object erasing processing as it is.

However, if “YES” in the step S153, that is, if the question data 72 exists, it is determined whether or not the current date and time is within the answer dead line of the question data 72 in a step S155. However, if the time for response is described (specified) as answer dead line data 72d, it is determined whether or not it is within the period.

If “NO” in the step S155, that is, if the current date and time is after the answer dead line of the question data 72, the process is returned to the player object erasing processing as it is. On the other hand, if “YES” in the step S155, that is, if the current date and time is within the answer dead line of the question data 72, the erasure flag is turned off in a step S157, and the process is returned to the player object erasing processing.

FIG. 32 is a flowchart showing erasure executing processing in the step S137 shown in FIG. 30. With reference to FIG. 32, when starting the erasure executing processing, the CPU 40 determines whether or not the erasure flag is turned on in a step S171. If “NO” in the step S171, that is, if the erasure flag is turned off, the screen is displayed showing that erasure is impossible due to the presence of the questionnaire which is being answered for the purpose of erasing the player data 70 in a step S173, and the process is returned to the player object erasing processing.

However, if “YES” in the step S171, that is, if the erasure flag is turned on, a screen for an erasure confirmation is displayed in a step S1175. That is, an erasure confirmation screen 900 shown in FIG. 20 is displayed. Then, in a step S1177, it is determined whether or not it is erasable. That is, it is determined whether or not erasure is agreed on the erasure confirmation screen 900. More specifically, it is determined whether or not the button 902 is turned on.

If “NO” in the step S1177, that is, if the button 904 is turned on the erasure confirmation screen 900, it is determined that erasure is impossible, and the player object erasing processing is returned as it is. On the other hand, if “YES” in the step S177, that is, if the button 902 is turned on the erasure confirmation screen 900, it is determined that erasure is possible, and the player data 70 as an erasable object is erased from the main memories (42e and 46), and the process is returned to the player object erasing processing.

FIG. 33-FIG. 35 show a flowchart showing questionnaire answering processing shown in the step S59 in FIG. 27. With reference to FIG. 33, when starting the questionnaire answering processing, the CPU 40 reads save data in a step S191. Thus, it is possible to know whether or not each player object has made an answer to the questionnaire with reference to the player data 70.

In a succeeding step S193, the question data 72 as to the questionnaire is read from the save data to display an answer screen 300 shown in FIG. 14 on the monitor 34. In a case that a player object which has made an answer to the questionnaire exists here, the player object is displayed so as to be grayed out in the first answer selection area 316b or the second answer selection area 316c according to the answer as described above.

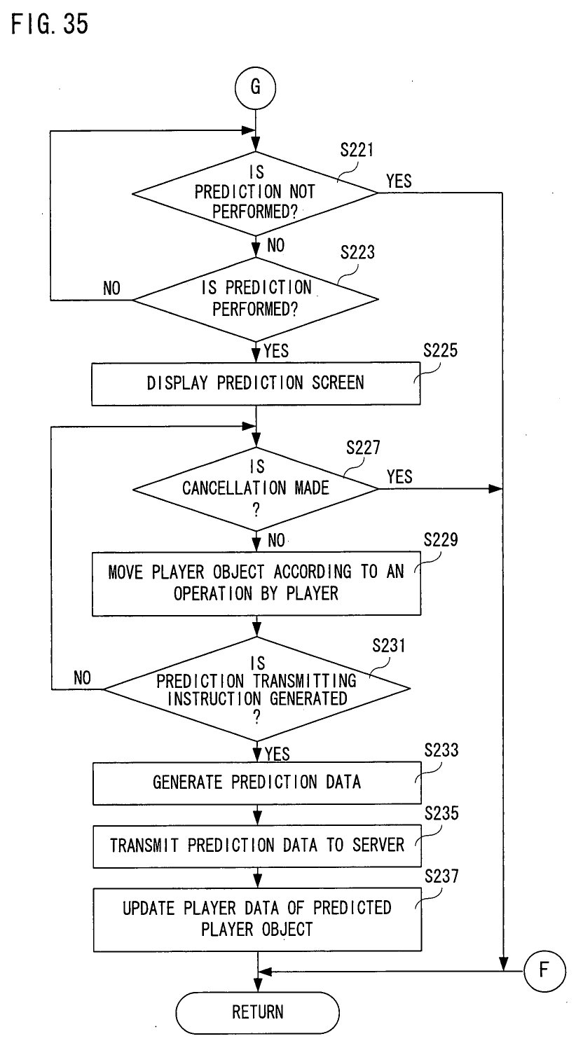

In a next step S195, it is determined whether or not a cancellation is made. That is, it is determined whether or not the button 302 is turned on the answer screen 300. If “YES” in the step S195, that is, if a cancellation is made, the process returns to the entire process as shown in FIG. 35. On the other hand, if “NO” in the step S195, that is, if a cancellation is not made, the player object is moved according to an operation by the player in a step S197. However, if the player performs no operation, the process proceeds to a step S199 as it is without executing the process in the step S197.

In the step S199, it is determined whether or not an answer instruction is generated. More specifically, it is determined whether or not the button 304 is turned on (answer instruction is input) on the answer screen 300. If “NO” in the step S199, that is, if an answer instruction is not generated, the process returns to the step S195 as it is. On the other hand, if “YES” in the step S199, that is, if an answer instruction is generated, answer data 74 is generated in a step S201, and the answer data 74 is transmitted to the server (delivery server 104) in a step S203. It should be noted that the answer data 74 includes only the content of the answer about the player object which makes an answer to the current questionnaire (question).

Succeedingly, in a step S205, player data 70 of the first player object is read. The process in the step S205 and onward is only executed on the player object which makes an answer to the current questionnaire. For convenience of explanation, a first player object and a next player object are called, but this means that the processing in the step S205 and the onward is executed on each of the player object which has made an answer.

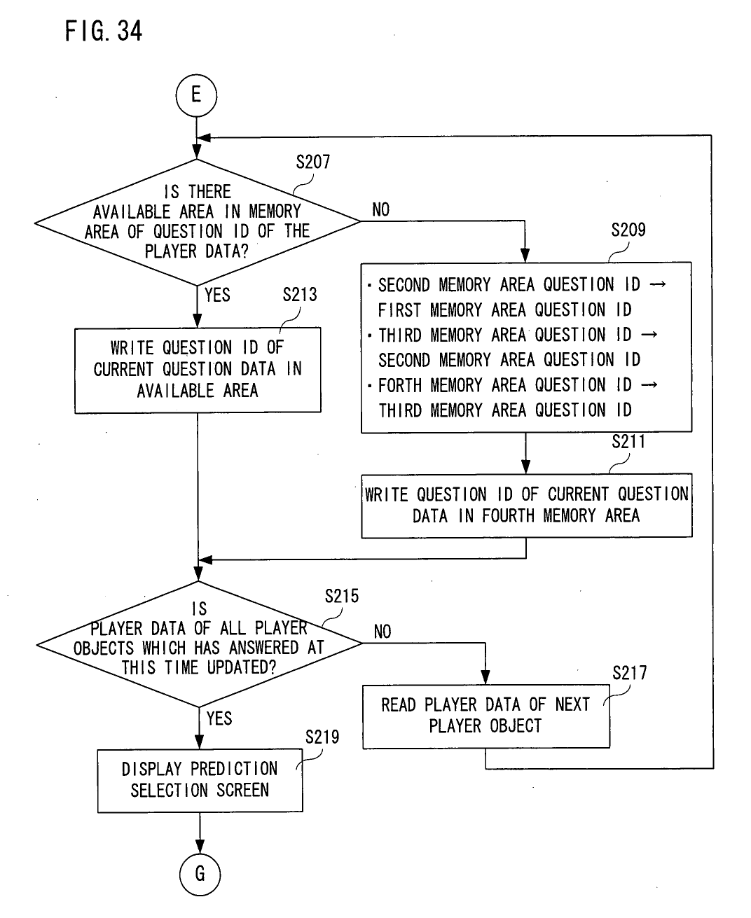

Next, in a step S207 shown in FIG. 34, it is determined whether or not there is an available area in the memory areas (70b1-70b4) of the player data 70. If “NO” in the step S207, that is, if there is no available area in the memory areas (70b1-70b4), the first memory area 70b1 is overwritten with a question ID of the second memory area 70b2, the second memory area 70b2 is overwritten with a question ID of the third memory area 70b3, and the third memory area 70b3 is overwritten with a question ID of the fourth memory area 70b4 in a step S209. Then, a question ID of the current question data 72 is written to (overwritten by) the fourth memory area 70b4 in a step S211, and the process proceeds to a step S215.

However, if “YES” in the step S207, that is, if there is an available area in the memory areas (70b1-70b4), the question ID of the current question data 72 is written to the available memory area (70b1-70b4) in a step S213, and then, the process proceeds to the step S215.

Additionally, as described above, in the memory areas (70b1-70b4), the question IDs are stored from the first memory area 70b1 in order, and therefore, if two or more memory areas (70b1-70b4) are available in the step S213, the question ID is stored in the memory area (70b1-70b4) earlier in order.

In the step S215, it is determined whether or not the player data 70 of all the player objects which make an answer at this time is updated. If “NO” in the step S215, that is, if there is player data 70 which have not been updated yet, player data 70 of a next player object is read in a step S217, and the process returns to the step S207. On the other hand, if “YES” in the step S215, that is, if the player data 70 of all the player objects which currently make an answer is updated, a prediction selection screen 400 as shown in FIG. 15 is displayed on the monitor 34 in a step S219.

Succeedingly, as shown in. FIG. 35, it is determined whether or not a prediction is not made in a step S221. More specifically, it is determined whether or not the button 404 is turned on the prediction selection screen 400 (no prediction is selected). If “YES” in the step S221, that is, if the button 404 is turned on, it is determined that no prediction is selected, and the process is returned to the entire process as it is. On the other hand, if “NO” in the step S221, that is, if the button 404 is not turned on, it is determined that no prediction is not selected, and it is determined whether or not a prediction is performed in a step S223. More specifically, it is determined whether or not the button 402 is turned on (predicting is selected) on the prediction selection screen 400.

If “NO” in the step S223, that is, if the button 402 is not turned on, it is determined that predicting is not selected, and the process returns to the step S221 as it is. On the other hand, if “YES” in the step S223, that is, if the button 402 is turned on, it is determined that the prediction is selected, and a prediction screen 500 shown in FIG. 16 is displayed on the monitor 34 in a step S225.

Succeedingly, in a step S227, it is determined whether or not a cancellation is made. More specifically, it is determined whether or not the button 502 is turned on the prediction screen 500 (returning to the initial screen 100 is instructed). If “YES” in the step S227, that is, if a cancellation is made, the process returns to the entire process as it is. On the other hand, if “NO” in the step S227, that is, if a cancellation is not made, a player object is moved according to an operation by the player in a step S229. However, if no operation is performed by the player, the process proceeds to a step S231 as it is without executing the processing in the step S229.

In the step S231, it is determined whether or not a prediction transmitting instruction is generated. More specifically, it is determined whether or not the button 504 is turned on the prediction screen 500 (a prediction transmission is instructed). If “NO” in the step S231, that is, if a prediction transmitting instruction is not generated, the process returns to the step S227 as it is. On the other hand, if “YES” in the step S231, that is, if a prediction transmitting instruction is generated, prediction data 76 is generated in a step S233, and the prediction data 76 is transmitted to the delivery server 104 in a step S235. Then, in a step S237, the player data 70 of the predicted player object is updated, and the process returns to the entire process. Strictly, in the step S237, the prediction data 70d is updated out of the player data 70.

FIG. 36 shows a flowchart showing result displaying processing in the step S63 shown in FIG. 27. With reference to FIG. 36, when starting the result displaying processing, the CPU 40 displays an entire result screen 600 shown in FIG. 17 on the monitor 34 in a step S251. In a succeeding step S253, it is determined whether or not a cancellation is made. More specifically, it is determined whether or not the button 602 is turned on the entire result screen 600 (an instruction for returning to the initial screen 100 is instructed).

If “YES” in the step S253, that is, if a cancellation is made, the process returns to the entire process as it is. On the other hand, if “NO” in the step S253, that is, if a cancellation is not made, it is determined whether or not displaying a detailed result is instructed in a step S255. More specifically, it is determined whether or not the button 604 is turned on the entire result screen 600 (displaying a detailed result is instructed).

If “YES” in the step S255, that is, if displaying a detailed result is instructed, a screen of the detailed result (not illustrated) is displayed in a step S257. It should be noted that as described above, a counting result with the sexes separated, a prediction accuracy, etc. are displayed on the screen of the detailed result. In a succeeding step S259, it is determined whether or not a cancellation is made. Here, if a cancellation is made, “YES” is determined, and the process returns to the step S253, but if a cancellation is not made, “NO” is determined, and the process returns to the step S259 as it is.

On the other hand, if “NO” in the step S255, that is, if displaying a detailed result is not instructed, it is determined whether or not displaying national results by region is instructed in a step S261. More specifically, it is determined whether or not the button 606 is turned on (display of the result for each region is instructed) on the entire result screen 600. If “NO” in the step S261, that is, if displaying the national results by region is not instructed, the process returns to the step S253, as it is. On the other hand, if “YES” in the step S261, that is, if displaying the national results by region is instructed, a national-results-by-region screen 700 shown in FIG. 18 is displayed in a step S263.

In a succeeding step S265, it is determined whether or not a cancellation is made. More specifically, the button 702 is turned on (returning to the initial screen 100 is instructed) on the national-results-by-region screen 700. If a cancellation is not made here, “NO” is determined, and the process returns to the same step S265 as it is, but if a cancellation is made, “YES” is determined, and the process returns to the step S253.

FIG. 37 is a flowchart showing questionnaire updating processing in the step S67 shown in FIG. 27. As shown in FIG. 37, when starting the questionnaire updating processing, the CPU 40 reads first question data 72 in a step S281. Here, question data 72 applied with a question ID stored in the area for display as header information is read from the main memories (42e and 46). It should be noted that in the questionnaire updating processing, the reason why the first question data 72, the next question data 72 are referred is that confirmation is made on each of the question data 72, and therefore, the question data 72 is read from the main memory (42e and 46) in an order of their being stored in the area for display.

In a step S283, it is determined whether or not an answer dead line of the question (questionnaire) indicated by the question data 72 expires. More specifically, it is determined whether or not the current date and time is after the answer dead line with reference to the answer dead line data 72d included in the question data 72.

If “NO” in the step S283, that is, if the dead line of the answer to the question indicated by the question data 72 does not expire, the process proceeds to a step S289 as it is. On the other hand, if “YES” in the step S283, that is, if the dead line of the answer to the question indicated by the question data 72 expires, relevant question data 72 (strictly, a corresponding question ID) is moved from the area for display to the result wait area in a step S285. In a succeeding step S287, a preliminary question data 72 is read. Here, a question ID of the preliminary question data 72 is stored in the area for display. Additionally, as described above, if a plurality of preliminary question data 72 is present, with reference to answer dead line data 72d of each question data 72, the oldest data (data having the closest answer dead line) is read.

Then, in the step S289, it is determined whether or not all the question data 72 is confirmed. If “NO” in the step S289, that is, if all the question data 72 is not confirmed, next question data 72 is read in the step S289, and the process returns to the step S283. On the other hand, if “YES” in the step S289, that is, if all the question data 72 is confirmed, the process returns to the entire process.

According to this embodiment, whether or not a questionnaire is answered is managed for each player object, and therefore, it is possible to effectively preventing a fraud like answering the same questionnaire by one player object.

Furthermore, in this embodiment, the player data of the player object which is answering the questionnaire cannot be erased, and therefore, it is possible to prevent the fraud like answering the same questionnaire at many times by repeating creation and erasure of the player data from occurring.

In addition, in this embodiment, the delivery server manages the number of answers to the same questionnaire from one game apparatus, and if the number of the player objects to be utilized becomes a maximum value, the answer from then on is not received, capable of preventing the fraud from occurring even if the player object is erased.

Additionally, the frauds described above can be avoided, capable of improving reliability of the counting result of the questionnaire.

In this embodiment, each player object can answer the questionnaire, and therefore, user data need not to be managed by the server, capable of reducing the load.

Furthermore, user data for a plurality of player objects are managed by single game apparatus, allowing a plurality of player objects (players or users) to make an answer to a single questionnaire on one screen (answer screen) as shown in the above-described embodiment.

In this embodiment, the delivery server distributes questionnaire data, accepts (receives) answer data, and distributes the collected result. However, a server or a computer for executing each function may be separately provided. In this case, the questionnaire collecting processing can be executed by a server accepting answer data or a server delivering collected results, or other servers or computers.

Furthermore, in this embodiment, questionnaire data and result data are included in the download data, and the game apparatus executes download processing to thereby receive (fetch) the data. However, there is no need to be limited thereto, and a delivery server may transmit questionnaire data and result data to a game apparatus.

In this embodiment, a description is only made on the game system separately provided with a game apparatus and a monitor. However, the game apparatus, which is connectable with a network like the Internet, may integrally be provided with a monitor. Furthermore, such a game apparatus includes a computer and a mobile phone provided with a game function.

Furthermore, the present invention need not to be limited to the game apparatus, and can be realized in versatile computers, which can manage player data as described above. In such a case, an MAC address of a communication means of the computer is used as identification information specific to the computer.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing a questionnaire answer program to be executed by a computer of a questionnaire answer apparatus communicably connected with a questionnaire delivery apparatus for delivering questionnaire data, an answer accepting apparatus for accepting answer data of a questionnaire, and a result delivery apparatus for delivering count result data of a questionnaire,
said questionnaire answer program causes said computer to execute:
a user data creating step for creating user data and storing the user data in a storing means,
a questionnaire data receiving step for receiving questionnaire data from said questionnaire delivery apparatus,
an answer data creating step for creating questionnaire answering data for each plurality of user data by presenting a questionnaire to a user by utilizing the questionnaire data received by said questionnaire data receiving step and accepting answers to the questionnaire for each plurality of user data created by said user data creating step,
an answer data transmitting step for transmitting said questionnaire answering data created by said answer data creating step to said answer accepting apparatus,
a count result data receiving step for receiving count result data from said result delivery apparatus, and
a count result presenting step for presenting a counting result to a user on the basis of the count result data received by said count result data receiving step.

2. A storage medium storing a questionnaire answer program according to claim 1, wherein
said questionnaire answer program causes the computer to further execute
a user data erasing step for erasing said user data from said storing means, and
an erasure prohibiting step for prohibiting erasure of the user data by said user data erasing step when a user corresponding to said user data makes an answer to a questionnaire indicated by said questionnaire data.

3. A storage medium storing a questionnaire answer program according to claim 2, wherein
said questionnaire answer program causes said computer to execute a user data selecting step for selecting said user data to be erased by said user data erasing step.

4. A storage medium storing a questionnaire answer program according to claim 3, wherein
said erasure prohibiting step excludes said user data from a candidate to be selected by said user selecting step when the user corresponding to said user data makes an answer to the questionnaire indicated by said questionnaire data.

5. A storage medium storing a questionnaire answer program according to claim 2, wherein
said questionnaire answer program causes said computer to execute a cancelling step for canceling the prohibition of the erasure by said erasure prohibiting step when said user data satisfies a predetermined condition.

6. A storage medium storing a questionnaire answer program according to claim 5, wherein
said questionnaire answer program causes said computer to further execute a count result data reception determining step for determining whether or not count result data corresponding to said questionnaire answering data is received by said count result data receiving step, and
said predetermined condition includes a fact that count result data corresponding to said questionnaire answering data is received by said count result data receiving step.

7. A storage medium storing a questionnaire answer program according to claim 5, wherein
said questionnaire data receiving step receives a plurality of kinds of questionnaire data,
said questionnaire answer program causes said computer to further execute a count result data reception determining step for determining whether or not count result data corresponding to all said questionnaire answering data is received by said count result data receiving step, and
said predetermined condition includes a fact that the count result data corresponding to all said questionnaire answering data is received by said count result data receiving step.

8. A storage medium storing a questionnaire answer program according to claim 1, wherein
said user data includes history information indicating that a questionnaire indicated by the questionnaire data is answered.

9. A storage medium storing a questionnaire answer program according to claim 8, wherein
said questionnaire answer program causes said computer to further execute an answer prohibiting step for prohibiting an answer to a questionnaire corresponding to questionnaire data indicating that an answer is made in said history information.

10. A storage medium storing a questionnaire answer program according to claim 1, wherein
said user data creating step creates user data in a range below a predetermined number.

11. A questionnaire answer system including a questionnaire answer apparatus which is communicatably connected to a questionnaire delivery apparatus for delivering questionnaire data, an answer accepting apparatus for accepting answer data of a questionnaire, and a result delivery apparatus for delivering count result data of a questionnaire, and makes an answer to a questionnaire by transmitting questionnaire answering data,
said questionnaire answer apparatus comprising:
a user data creating means for creating user data and storing the user data in a storing means,
a questionnaire data receiving means for receiving questionnaire data from said questionnaire delivery apparatus,
an answer data creating means for creating questionnaire answering data each plurality of user data by presenting a questionnaire to a user by utilizing the questionnaire data received by said questionnaire data receiving means and accepting answers to the questionnaire for each plurality of user data created by said user data creating means,
an answer data transmitting means for transmitting said questionnaire answering data created by said answer data creating means to said answer accepting apparatus,
a count result data receiving means for receiving count result data from said result delivery apparatus, and
a count result presenting means for presenting a counting result to a user on the basis of the count result data received by said count result data receiving means.

12. A questionnaire answer system according to claim 11, wherein
said questionnaire answer apparatus further comprises:
a user data erasing means for erasing said user data from said storing means, and
an erasure prohibiting means for prohibiting erasure of the user data by said user data erasing means when a user corresponding to said user data makes an answer to a questionnaire indicated by said questionnaire data.

13. A questionnaire answer system according to claim 12, wherein
said questionnaire answer apparatus further comprises a user data selecting means for selecting said user data to be erased by said user data erasing means.

14. A questionnaire answer system according to claim 13, wherein
said erasure prohibiting means excludes said user data from a candidate to be selected by said user selecting means when the user corresponding to said user data makes an answer to the questionnaire indicated by said questionnaire data.
